(19) United States
(12) Patent Application Publication
(10) Pub. No.: US 2014/0297374 A1
(43) Pub. Date: Oct. 2, 2014

(54) PRODUCTION MANAGEMENT SYSTEM AND MANAGEMENT METHOD

(71) Applicant: HITACHI, LTD., TOKYO (JP)

(72) Inventors: KATSUNARI IKEZAWA, TOKYO (JP); MASAHIRO SATO, TOKYO (JP); KAZUNOBU AIZAWA, HITACHINAKA (JP)

(73) Assignee: HITACHI, LTD., TOKYO (JP)

(21) Appl. No.: 14/169,855

(22) Filed: Jan. 31, 2014

(30) Foreign Application Priority Data
Mar. 29, 2013 (JP) 2013-072436

(51) Int. Cl. G06Q 10/06

(52) U.S. Cl. CPC G06Q 10/06395
USPC 705/7.41

(57) ABSTRACT

A production management system for managing at least one process for producing a product, has a terminal and a management computer. The management computer obtains actual performance information from the terminal, and calculates a discrepancy of the actual performance value of the process from the reference value. In a case where the calculated discrepancy is outside a threshold, the management computer displays an alert display screen. In a case where one of the processes is selected on the alert display screen, the management computer displays a details displaying screen that includes, for each product, an actual performance value in the selected process.

### CLAIM OF PRIORITY

The present application claims priority from Japanese patent application JP 2013-72436 filed on Mar. 29, 2013, the content of which is hereby incorporated by reference into this application.

### BACKGROUND OF THE INVENTION

This invention relates to a production management system for managing processes for producing a product.

In the manufacturing industry, it is necessary to take into consideration a diversity of variable factors such as fluctuations in demand for a product, the yield in a production process, fluctuations in production lead time, and fluctuations in parts procurement lead time. A lead time is a time measured from the start of a process to the finish.

A producer can generally deal with these fluctuations by stocking parts, intermediate products, and finished products. For instance, when a drop in yield is foreseen in a particular process, the producer can prevent a shipping delay by increasing stocks of a product that is produced in the particular process. A yield is the proportion of non-defective products to all products. On the other hand, a producer invites the risk of increased inventory assets when they overstock, and would want to stock an appropriate amount at appropriate timing.

The appropriate amount of stocks needs to be derived based on fluctuations in demand, fluctuations in yield, equipment troubles, a delay of delivery from a supplier, and the like, which are not constant values and fluctuate all the time. In addition, not only values at a particular point in time but also the long-term fluctuation trend that takes into account the life cycle of the product needs to be considered in deriving the appropriate amount of stocks. It is not easy to derive an amount to be stocked by taking all these variable factors into consideration so that the derived amount is reflected on the production schedule.

Japanese Patent Application Laid-open No. 2005-63084 (Patent Document 1) is one of technologies for displaying actual performance information which is collected from a production line and production schedule information to keep track of the discrepancy between the two. Descriptions given in this publication include: “a delivery date (delivery lead time), material balance, quality, and productivity such as work man hours are displayed instantly, and an alert is issued under a given condition, to thereby prompt a remedial action and improve the productivity of a production process. The interchangeability between display formats is further secured by displaying in one of display formats selected from a Gantt chart that has a vertical time axis, a Gantt chart that has a horizontal time axis, and a table format, based on time restraints of the process (=a production lead time). An input/output interface is designed so as to correspond to a chart bar or cells in a table format”.

### SUMMARY OF THE INVENTION

When there is a discrepancy between the schedule of a product and actual performance, an administrator identifies the cause of the discrepancy by tracing back the process of the product and investigating the cause of the delay. The problem, however, is that many man hours are required in order for the administrator to identify the cause due to complexity inherent in the production process of a product, with regard to branching and merging of processes, shared parts and shared lines, and the like.

Patent Document 1 describes a production management system that visualizes information about the progress of a process at a site where multiple types of products are produced. The production management system of Patent Document 1 can display schedule information and actual performance information separately on a Gantt chart, and manage equipment information and information about productivity which includes yield. However, this production management system is not capable of analyzing how a change in delivery date or quantity in a particular process affects other processes, which process is the cause of a delivery delay, and the like.

There is a diversity of variable factors at a production site. For instance, demands from customers constantly change. The yield in a production line fluctuates all the time and productivity can drop due to an equipment trouble. Consequently, actual completion performance often does not exactly meet the schedule.

In view of the problems described above, an object of this invention is to provide a production management system that facilitates the identification of the cause of a discrepancy between a schedule and actual performance.

According to an aspect of the present invention, there is provided a production management system for managing at least one process for producing a product, comprising: a terminal for managing actual performance of the process; and a management computer for managing the terminal, wherein the terminal stores actual performance information which includes, for each product, an actual performance value in the process, wherein the management computer stores reference information which includes, for each product, a reference value in the process, and wherein the management computer is configured to: obtain the actual performance information from the terminal; compare, for each process, an actual performance value included in a piece of the obtained actual performance information of the process against a reference value included in a piece of the reference information that is associated with the process, to thereby calculate, for each process, a discrepancy of the actual performance value of the process from the reference value; in a case where the calculated discrepancy is outside a threshold, display an alert display screen where every process for which the calculated discrepancy is outside the threshold is displayed in a manner that indicates an alert; and in a case where one of the processes is selected on the alert display screen, display a details displaying screen that includes, for each product, an actual performance value in the selected process.

An effect of the exemplary embodiment of the invention disclosed herein is summarized as follows. This invention enables to provide a production management system that facilitates the identification of the cause of a discrepancy between a schedule and actual performance.

Other objects, configurations, and effects than those described above are made clear in the following description of embodiments.

### BRIEF DESCRIPTION OF THE DRAWINGS

The present invention can be appreciated by the description which follows in conjunction with the following figures, wherein:

FIG. 1 is an explanatory diagram of a production management system according to a first embodiment of this invention;

FIG. 2 is an explanatory diagram of an outline of a production process according to the first embodiment of this invention;

FIG. 3 is a hardware configuration diagram of a production management department server according to the first embodiment of this invention;

FIG. 4 is an explanatory diagram of shipping request information according to the first embodiment of this invention;

FIG. 5 is an explanatory diagram of shipping request fulfillment information according to the first embodiment of this invention;

FIG. 6 is an explanatory diagram of actual parts order performance information according to the first embodiment of this invention;

FIG. 7 is an explanatory diagram of actual parts arrival performance information according to the first embodiment of this invention;

FIG. 8 is an explanatory diagram of actual input performance information according to the first embodiment of this invention;

FIG. 9 is an explanatory diagram of actual completion performance information according to the first embodiment of this invention;

FIG. 10 is an explanatory diagram of actual stocking performance information according to the first embodiment of this invention;

FIG. 11 is an explanatory diagram of actual stock retrieval performance information according to the first embodiment of this invention;

FIG. 12 is a flow chart of overall processing of the production management department server according to the first embodiment of this invention;

FIG. 13 is a flow chart of actual performance information obtaining processing according to the first embodiment of this invention;

FIG. 14 is a flow chart of reference value obtaining processing according to the first embodiment of this invention;

FIG. 15 is a flow chart of discrepancy calculating processing according to the first embodiment of this invention;

FIG. 16 is an explanatory diagram of alert display screen according to the first embodiment of this invention;

FIG. 17 is an explanatory diagram of an appropriate stock details screen according to the first embodiment of this invention;

FIG. 18 is an explanatory diagram of an alert display screen according to a modification example of the first embodiment of this invention;

FIG. 19 is an explanatory diagram of a preceding/following process actual performance details screen according to a second embodiment of this invention;

FIG. 20 is an explanatory diagram of a shipping destination actual performance display area according to a third embodiment of this invention;

FIG. 21 is an explanatory diagram of a transition in shipping request count according to the third embodiment of this invention;

FIG. 22 is an explanatory diagram of the actual completion performance information according to a fourth embodiment of this invention;

FIG. 23 is an explanatory diagram of yield reference value information according to the fourth embodiment of this invention;

FIG. 24 is an explanatory diagram of a preceding actual performance details screen according to the fourth embodiment of this invention;

FIG. 25 is an explanatory diagram of completion schedule information according to a fifth embodiment of this invention;

FIG. 26 is an explanatory diagram of an advance day count modifying screen according to the fifth embodiment of this invention;

FIG. 27 is an explanatory diagram of a next process starting schedule modification suggestion according to the fifth embodiment of this invention that is displayed in the case where the period of an actual completion performance never exceeds the period of a next process starting schedule;

FIG. 28 is an explanatory diagram of an advance day count modifying screen according to the fifth embodiment of this invention that is displayed in the case where every period of the actual completion performance exceeds the period of the next process starting schedule; and

FIG. 29 is an explanatory diagram of the advance day count modifying screen according to the fifth embodiment of this invention that is displayed in the case where no period of the actual completion performance exceeds the period of the next process starting schedule.

### DETAILED DESCRIPTION OF THE PREFERRED EMBODIMENTS

Embodiments of this invention are described in detail below with reference to the drawings. Components that are substantially the same are denoted by the same reference symbol in order to avoid repetitive descriptions.

### First Embodiment

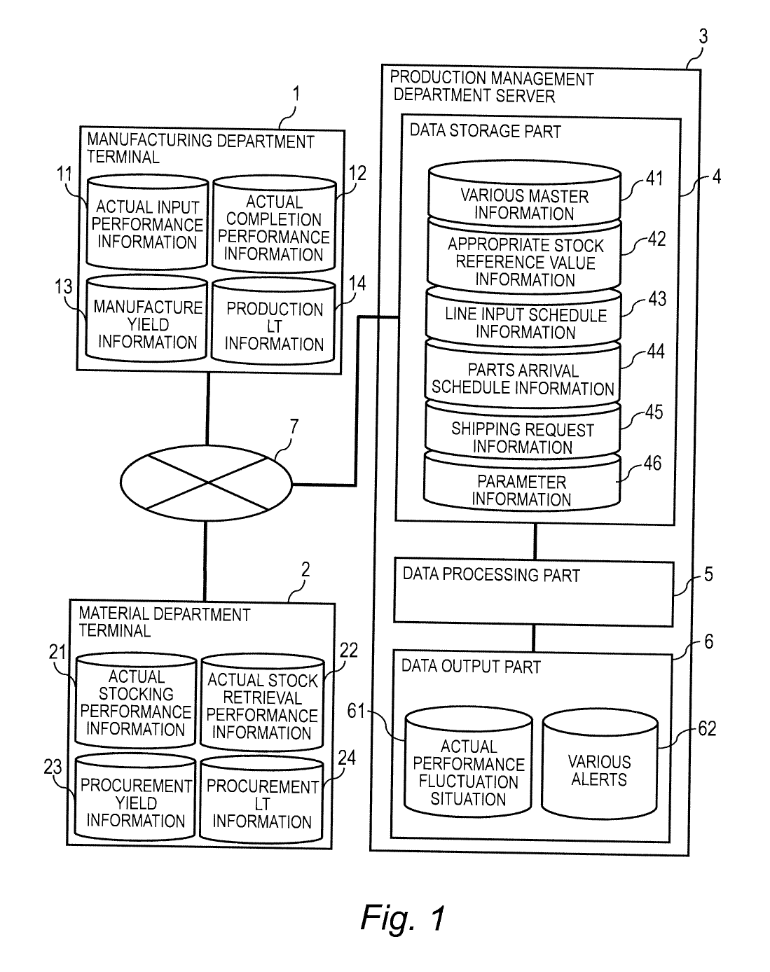

A first embodiment of this invention is described below with reference to FIGS. 1 to 18.

FIG. 1 is an explanatory diagram of a production management system according to the first embodiment of this invention.

The production management system includes a manufacturing department terminal 1, a material department terminal 2, and a production management department server (management computer) 3. The manufacturing department terminal 1, the material department terminal 2, and the production management department server 3 are coupled to one another via a network 7. The manufacturing department terminal 1 and the material department terminal 2 are collectively referred to as terminals.

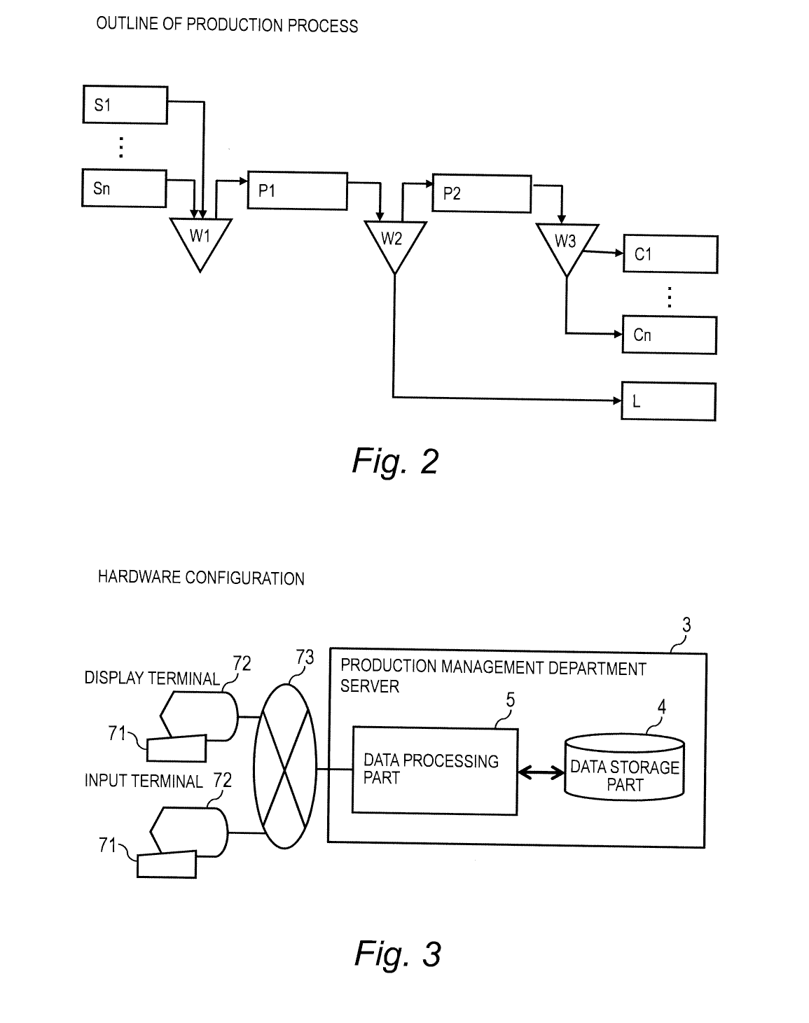

The manufacturing department terminal 1 is a terminal for managing actual performance information of a manufacturing process which is included in a production process illustrated in FIG. 2. The manufacturing department terminal 1 stores actual input performance information 11, actual completion performance information 12, manufacture yield information 13, and production lead time (LT) information 14. These pieces of information are collectively referred to as actual performance information.

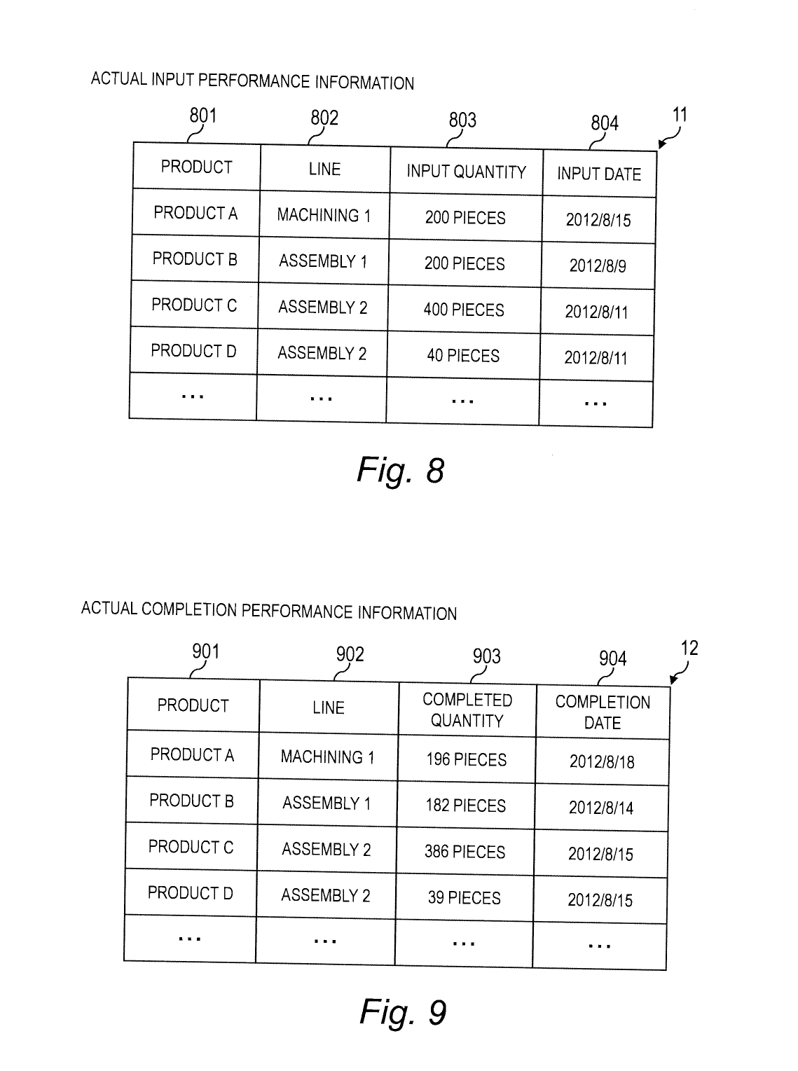

The actual input performance information 11 is for managing the count of input articles that are input to a manufacturing process, and details thereof are described with reference to FIG. 8. The actual completion performance information 12 is for managing the count of completed articles that are completed in a manufacturing process, and details thereof are described with reference to FIG. 9.

The manufacture yield information 13 is for managing the yield in a manufacturing process, and includes a yield and the cause of defective products in the manufacturing process. The yield of the manufacture yield information 13 is calculated by dividing the count of completed articles of the actual completion performance information 12 by the count of input articles of the actual input performance information 11. The production LT information 14 is for managing a lead time that indicates a period of time from input to completion in a manufacturing process. The lead time of the production LT information 14 is calculated by subtracting the date of input of the actual input performance information 11 from the date of completion of the actual completion performance information 12. The manufacturing department terminal 1 is therefore required to store at least the actual input performance information 11 and the actual completion performance information 12, and does not always need to store the manufacture yield information 13 and the production LT information 14.

The material department terminal 2 is a terminal for managing actual performance information of a storing process which is included in the production process illustrated in FIG. 2. The material department terminal 2 stores actual stocking performance information 21, actual stock retrieval performance information 22, procurement yield information 23, and procurement LT information 24. These pieces of information are collectively referred to as actual performance information.

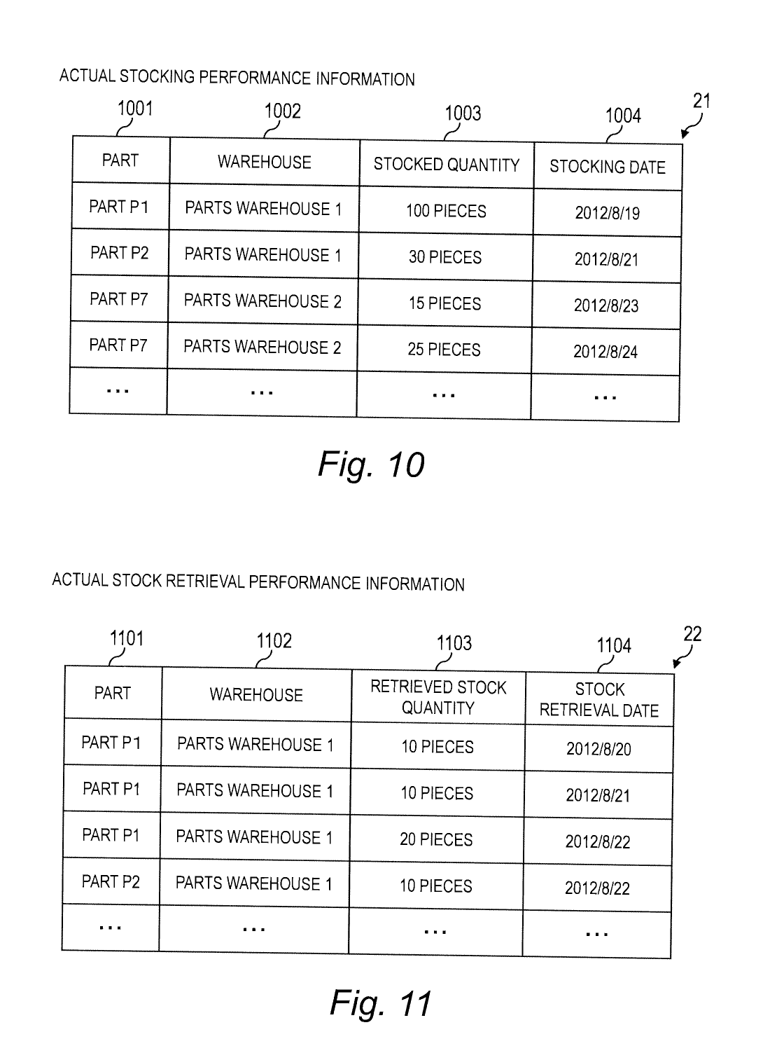

The actual stocking performance information 21 is for managing the count of articles in stock that are stocked in a warehouse in a storing process, and details thereof are described with reference to FIG. 10. The actual stock retrieval performance information 22 is for managing the count of retrieved stocks that are retrieved from a warehouse in a storing process, and details thereof are described with reference to FIG. 11.

The procurement yield information 23 is for managing the yield in a storing process. The yield of the procurement yield information 23 is calculated by dividing the count of retrieved stocks of the actual stock retrieval performance information 22 by the count of in-stock articles of the actual stocking performance information 21. The procurement LT information 24 is for managing a lead time that indicates a period of time from stocking to stock retrieval in a storing process. The lead time of the procurement LT information 24 is calculated by subtracting the date of stocking of the actual stocking performance information 21 from the date of stock retrieval of the actual stock retrieval performance information 22. The material department terminal 2 is therefore required to store at least the actual stocking performance information 21 and the actual stock retrieval performance information 22, and does not always need to store the procurement yield information 23 and the procurement LT information 24.

The production management department server 3 includes a data storage part 4, a data processing part 5, and a data output part 6.

The data storage part 4 is an area for storing various types of information, and stores various master information 41, appropriate stock reference value information 42, line input schedule information 43, parts arrival schedule information 44, shipping request information 45, and parameter information 46.

Registered as the various master information 41 are reference values of the various types of actual performance information stored in the manufacturing department terminal 1 and the material department terminal 2. A reference value of the appropriate amount of stocks for a warehouse in a storing process is registered as the appropriate stock reference value information 42. These are collectively referred to as reference values.

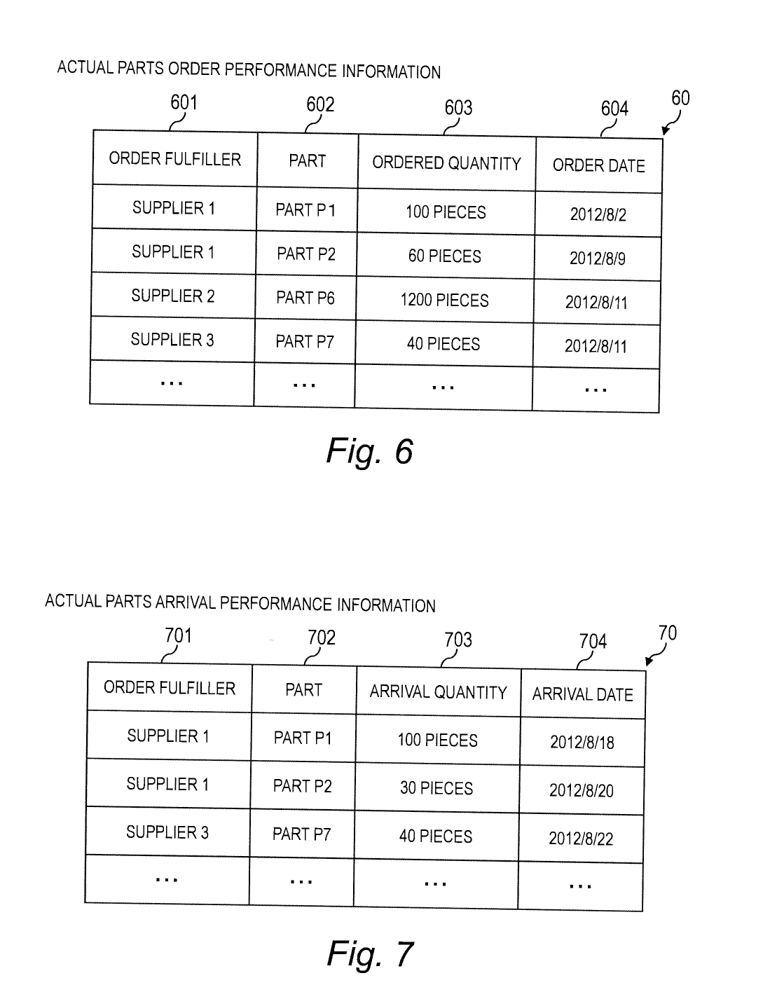

Registered as the line input schedule information 43 are a schedule for input to a manufacturing process and the count of articles that are planned to be completed in the manufacturing process. Registered as the parts arrival schedule information 44 is a schedule for the arrival of parts at a warehouse in a storing process from a fulfiller of an order for the parts (a supplier). The count of products requested by a customer to whom the products are shipped is registered as the shipping request information 45, among others. Details of the shipping request information 45 are described with reference to FIG. 6.

Parameters for the ranges of various reference values are registered as the parameter information 46, among others.

The data processing part 5 is an arithmetic processing part that reads information out of the data storage part 4 and executes arithmetic processing. The data processing part 5 is, for example, a processor.

The data output part 6 is a display or the like that outputs data to an administrator, and outputs an actual performance fluctuation situation 61 and various alerts 62. The actual performance fluctuation situation 61 is time-series changes of the various types of actual performance information collected from the manufacturing department terminal 1 and the material department terminal 2. The various alerts 62 are alerts for notifying the administrator of the fact that discrepancies between the various types of actual performance information collected from the manufacturing department terminal 1 and the material department terminal 2 and reference values associated with the actual performance information are equal to or greater than thresholds.

FIG. 2 is an explanatory diagram of the outline of a production process according to the first embodiment of this invention.

The production process of this embodiment includes, for example, two manufacturing processes, P1 and P2, and three storing processes, W1 to W3.

First, materials procured from suppliers S1 to Sn are stored in a warehouse in the storing process W1. In the manufacturing process P1, the materials stored in the storing process W1 are input to undergo processing of the manufacturing process P1 such as machining, and a product is thus manufactured. The product processed in the manufacturing process P1 is stored in a warehouse in the storing process W2.

The product stored in a warehouse in the storing process W2 is input to the manufacturing process P2 or shipped to a line L of a customer who treats the product as a material. An unfinished product that is input to another manufacturing process or shipped to a shipping destination as this is called an intermediate product.

In the manufacturing process P2, the intermediate product stored in the storing process W2 is input to undergo processing of the manufacturing process P2, and a product is thus manufactured. The product processed in the manufacturing process P2 is stored in a warehouse in the storing process W3. The product stored in a warehouse in the storing process W3 is shipped to customers C1 to Cn.

The manufacturing department terminal 1 is disposed for each of the manufacturing processes P1 and P2 to store actual performance information of the manufacturing processes P1 and P2. The material department terminal 2 is disposed for each of the storing processes W1 to W3 to store actual performance information of the storing processes W1 to W3.

The production management department server 3 also stores in the data storage part 4 Bill of Process (BOP) information, which includes process order information (not shown) for registering a process order that indicates the order of the processes of FIG. 2.

FIG. 3 is a hardware configuration diagram of the production management department server 3 according to the first embodiment of this invention.

The production management department server 3 includes the data storage part 4 and the data processing part 5 as illustrated in FIG. 1, and is coupled to an input terminal 71 and a display terminal 72 via a network 73.

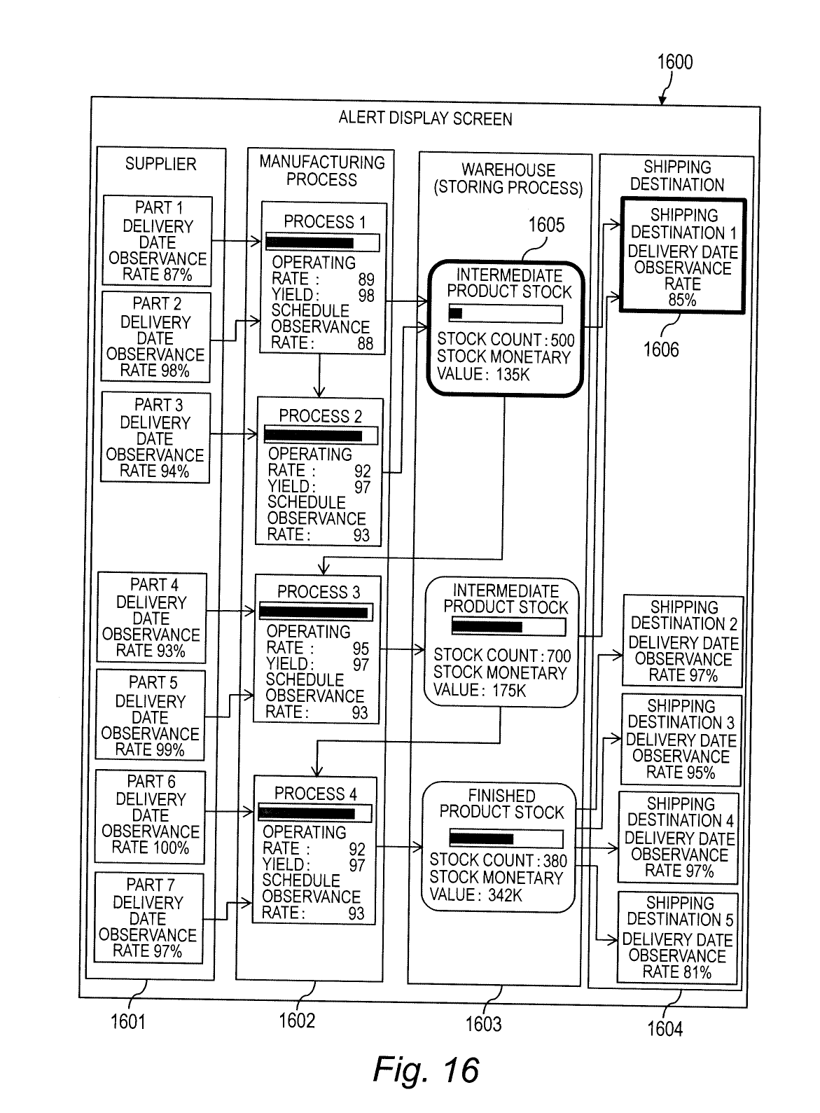

An alert display screen 1600 (illustrated in FIG. 16) which shows the various alerts 62 is output to the display terminal 72, among others. The input terminal 71 is operated by the administrator to identify the causes of the various alerts 62 output to the display terminal 72, or to narrow down the targets of the various alerts 62.

The production management department server 3 is described as an independent information system in this embodiment. However, this invention is not limited thereto. For instance, the function of the production management department server 3 may be incorporated in another information processing system to function as a part of the other information processing system.

The input terminal 71 and the display terminal 72 may be connected directly to the production management department server 3, instead of being coupled to the production management department server 3 via the network 73.

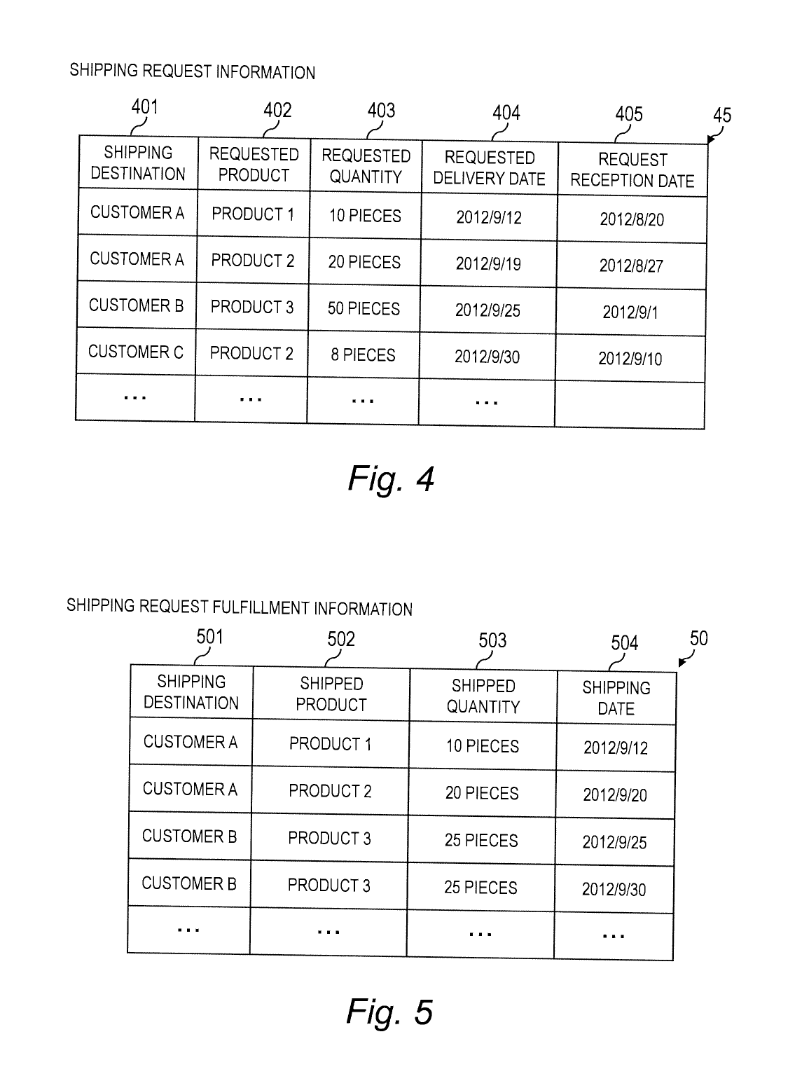

FIG. 4 is an explanatory diagram of the shipping request information 45 according to the first embodiment of this invention.

A customer connection terminal (not shown) which is coupled to a terminal (not shown) of a customer receives a shipping request from the customer. Receiving the request, the customer connection terminal stores the shipping request information 45 and transmits the stored shipping request information 45 to the production management department server 3. The production management department server 3 stores the received shipping request information 45.

The shipping request information 45 includes a shipping destination 401, a requested product 402, a requested quantity 403, a requested delivery date 404, and a request reception date 405.

Registered as the shipping destination 401 is the identifier of a customer who has requested the shipping of a product and to whom the product is shipped. The identifier of the product requested to be shipped is registered as the requested product 402. The count of pieces of the product requested to be shipped is registered as the requested quantity 403. The delivery date of the product requested to be shipped is registered as the requested delivery date 404. A date (including the year) at which the shipping request has been received by the customer connection terminal (not shown) is registered as the request reception date 405.

FIG. 5 is an explanatory diagram of shipping request fulfillment information 50 according to the first embodiment of this invention.

At the time a product requested to be shipped is actually shipped, the shipped quantity and the like are registered in the shipping request fulfillment information 50. For example, in the case where an intermediate product is shipped to a customer L in the storing process W2 and a finished product is shipped to the customers C1 to Cn in the storing process W3 in FIG. 2, these actual shipping records are stored in the material department terminals 2 for the storing processes W2 and W3, and the stored actual shipping records are transmitted to the production management department server 3. The shipping request fulfillment information 50, though not shown in FIG. 1, is stored in the material department terminal 2 for a storing process that involves shipping to a customer, and in the production management department server 3.

The shipping request fulfillment information 50 includes a shipping destination 501, a shipped product 502, a shipped quantity 503, and a shipping date 504.

Registered as the shipping destination 501 is the identifier of a customer to whom the product is shipped. The identifier of the shipped product is registered as the shipped product 502. The count of pieces of the product shipped is registered as the shipped quantity 503. A date (including the year) at which the product has been shipped is registered as the shipping date 504.

FIG. 6 is an explanatory diagram of actual parts order performance information 60 according to the first embodiment of this invention.

A supplier connection terminal (not shown) which is coupled to a terminal (not shown) of a supplier who supplies parts stores the actual parts order performance information 60 when an order for parts is placed at the supplier. The count of parts ordered and the like are registered as the actual parts order performance information 60. The supplier connection terminal transmits the stored actual parts order performance information 60 to the production management department server 3, which stores the received actual parts order performance information 60.

The actual parts order performance information 60 includes an order fulfiller 601, a part 602, an ordered quantity 603, and an order date 604.

Registered as the order fulfiller 601 is the identifier of a supplier at which an order for a part is placed. The identifier of the ordered part is registered as the part 602. The count of pieces of the part ordered is registered as the ordered quantity 603. A date (including the year) at which the order for the part has been placed is registered as the order date 604.

FIG. 7 is an explanatory diagram of actual parts arrival performance information 70 according to the first embodiment of this invention.

When parts arrive at a warehouse from a supplier, the count of parts that have arrived and the like are registered as the actual parts arrival performance information 70. For example, in the case where parts arrive at a warehouse from a supplier in the storing process W1 in FIG. 2, this actual parts arrival record is stored by the material department terminal 2 and the stored actual parts arrival record is transmitted to the production management department server 3. The actual parts arrival performance information 70, though not shown in FIG. 1, is stored in the material department terminal 2 for a storing process in which parts arrive from a supplier, and in the production management department server 3.

The actual parts arrival performance information 70 includes an order fulfiller 701, a part 702, an arrival quantity 703, and an arrival date 704.

Registered as the order fulfiller 701 is the identifier of a supplier at which an order for a part that has arrived is placed. The identifier of the part that has arrived is registered as the part 702. The count of pieces of the part that have arrived is registered as the arrival quantity 703. A date (including the year) at which the part has arrived is registered as the arrival date 704.

FIG. 8 is an explanatory diagram of the actual input performance information 11 according to the first embodiment of this invention.

For each manufacturing process (line), the count of input products and the like are registered as the actual input performance information 11 when products are input to the manufacturing process. The actual input performance information 11 is stored in the manufacturing department terminal 1 as illustrated in FIG. 1. The production management department server 3 collects the actual input performance information 11 from the manufacturing department terminal 1, to thereby store the actual input performance information 11 in the production management department server 3 as well.

The actual input performance information 11 includes a product 801, a line 802, an input quantity 803, and an input date 804.

Registered as the product 801 is the identifier of a product input to a manufacturing process. The identifier of the manufacturing process to which the product has been input is registered as the line 802. The count of pieces of the product input to the manufacturing process is registered as the input quantity 803. A date (including the year) at which the product has been input to the manufacturing process is registered as the input date 804.

FIG. 9 is an explanatory diagram of the actual completion performance information 12 according to the first embodiment of this invention.

The count of products for which a manufacturing process is completed is registered as the actual completion performance information 12 at the time of the completion of the manufacturing process. The actual completion performance information 12 is stored in the manufacturing department terminal 1 as illustrated in FIG. 1. The production management department server 3 collects the actual completion performance information 12 from the manufacturing department terminal 1, to thereby store the actual completion performance information 12 in the production management department server 3 as well.

The actual completion performance information 12 includes a product 901, a line 902, a completed quantity 903, and a completion date 904.

Registered as the product 901 is the identifier of a product for which a manufacturing process has been completed. The identifier of a line for which the manufacturing process has been completed is registered as the line 902. The count of pieces of the product for which the manufacturing process has been completed is registered as the completed quantity 903. A date (including the year) at which the manufacturing process has been completed is registered as the completion date 904.

FIG. 10 is an explanatory diagram of the actual stocking performance information 21 according to the first embodiment of this invention.

The count of stocked parts and the like are registered as the actual stocking performance information 21 when parts (or products) are stocked in a warehouse in a storing process. The actual stocking performance information 21 is stored in the material department terminal 2 as illustrated in FIG. 1. The production management department server 3 collects the actual stocking performance information 21 from the material department terminal 2, to thereby store the actual stocking performance information 21 in the production management department server 3 as well.

The actual stocking performance information 21 includes a part 1001, a warehouse 1002, a stocked quantity 1003, and a stocking date 1004.

Registered as the part 1001 is the identifier of a part stocked in a warehouse. The identifier of the warehouse in which the part has been stocked is registered as the warehouse 1002. The count of pieces of the part stocked in the warehouse is registered as the stocked quantity 1003. A date (including the year) at which the part has been stocked in the warehouse is registered as the stocking date 1004.

FIG. 11 is an explanatory diagram of the actual stock retrieval performance information 22 according to the first embodiment of this invention.

The count of retrieved parts and the like are registered as the actual stock retrieval performance information 22 when parts are retrieved from a warehouse in a storing process. The actual stock retrieval performance information 22 is stored in the material department terminal 2 as illustrated in FIG. 1. The production management department server 3 collects the actual stock retrieval performance information 22 from the material department terminal 2, to thereby store the actual stock retrieval performance information 22 in the production management department server 3 as well.

The actual stock retrieval performance information 22 includes a part 1101, a warehouse 1102, a retrieval stock quantity 1103, and a stock retrieval date 1104.

Registered as the part 1101 is the identifier of a part retrieved from a warehouse. The identifier of the warehouse from which the part has been retrieved is registered as the warehouse 1102. The count of pieces of the part retrieved from the warehouse is registered as the retrieved stock quantity 1103. A date (including the year) at which the part has been retrieved from the warehouse is registered as the stock retrieval date 1104.

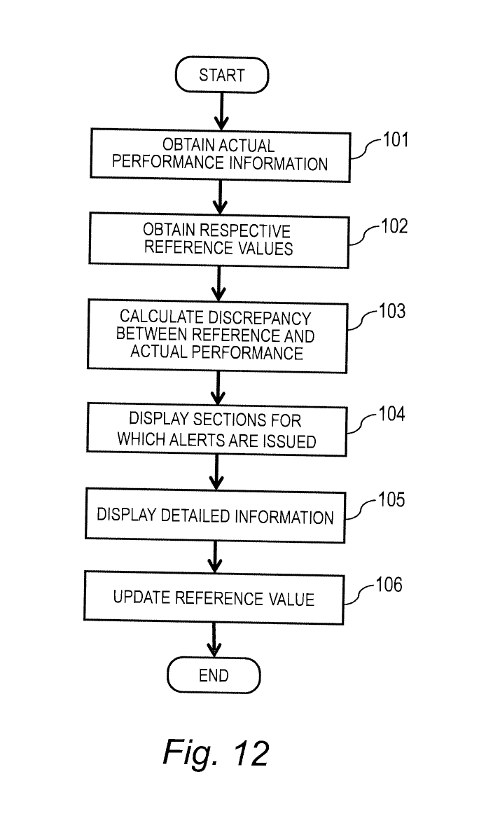

Overall processing of the production management department server 3 is described next with reference to FIG. 12. FIG. 12 is a flow chart of overall processing of the production management department server 3 according to the first embodiment of this invention.

The production management department server 3 first obtains actual performance information stored in the manufacturing department terminal 1, the material department terminal 2, and other components (101). For example, the production management department server 3 transmits a request to obtain actual performance information to the manufacturing department terminal 1, the material department terminal 2, and other components. The manufacturing department terminal 1, the material department terminal 2, and other components that have received the request to obtain actual performance information each transmit its own stored actual performance information to the production management department server 3. The production management department server 3 obtains actual performance information by receiving these pieces of actual performance information.

The production management department server 3 next refers to the various master information 41 and the appropriate stock reference value information 42, which are stored in the data storage part 4, to obtain reference values that are associated with the actual performance information obtained in Step 101 (102).

The production management department server 3 calculates a differential of the actual performance information obtained in Step 101 from the reference values obtained in Step 102, to thereby calculate a discrepancy from reference values for actual performance information (103).

In the case where the differential calculated in Step 103 is equal to or more than a threshold, the production management department server 3 generates the alert display screen 1600 in order to notify the administrator of an alert for a process that corresponds to the piece of actual performance information in question, and displays the generated alert display screen 1600 (104). Details of the alert display screen 1600 are described with reference to FIG. 16.

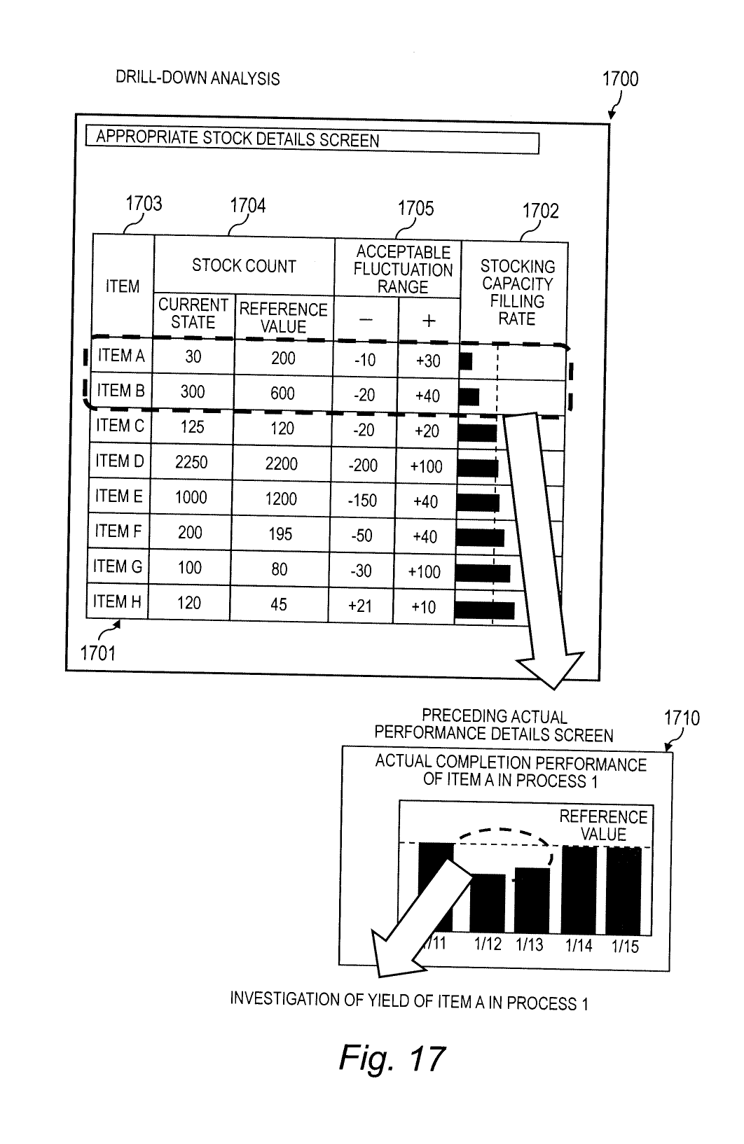

When one of the processes is selected on the alert display screen 1600 displayed in Step 104, the production management department server 3 generates an appropriate stock details screen 1700 (illustrated in FIG. 17) for displaying detailed information of the selected process, and displays the generated appropriate stock details screen 1700 (105).

The administrator refers to the alert display screen 1600 and the appropriate stock details screen 1700 and, in the case of modifying a reference value, enters a new reference value to the production management department server 3.

When an input of a new reference value is received, the production management department server 3 updates a reference value that is to be replaced by the received reference value with the received reference value (106), and ends the processing.

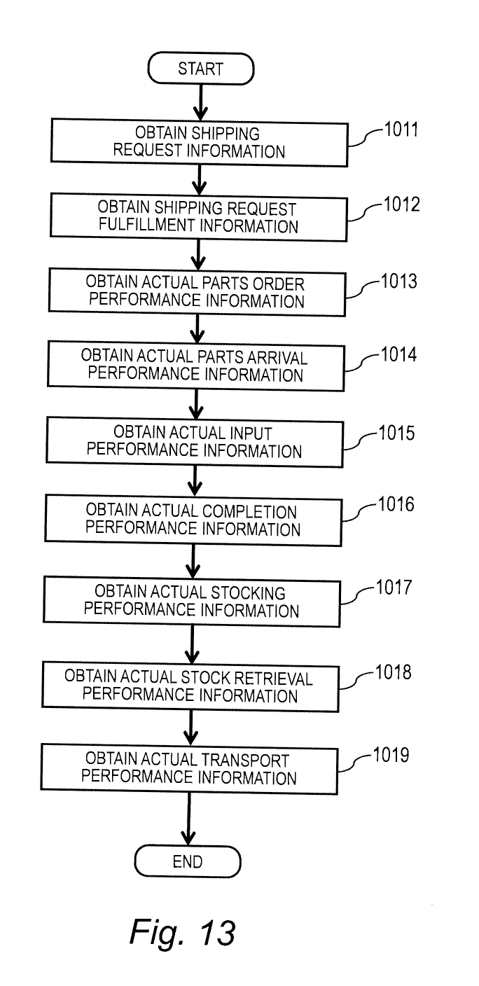

The processing of obtaining actual performance information of Step 101 is described next with reference to FIG. 13. FIG. 13 is a flow chart of actual performance information obtaining processing according to the first embodiment of this invention.

When the actual performance information obtaining processing is started in Step 101, the production management department server 3 obtains the shipping request information 45 from the customer connection terminal (not shown), and stores the obtained shipping request information 45 (1011).

The production management department server 3 obtains the shipping request fulfillment information 50 from the material department terminal 2 for a warehouse that is holding a product to be shipped to the customer, and stores the obtained shipping request fulfillment information 50 (1012).

The production management department server 3 obtains the actual parts order performance information 60 from the supplier connection terminal (not shown), and stores the obtained actual parts order performance information 60 (1013).

The production management department server 3 obtains the actual parts arrival performance information 70 from the material department terminal 2 for a warehouse at which the parts arrive from the supplier, and stores the obtained actual parts arrival performance information 70 (1014).

The production management department server 3 obtains the actual input performance information 11 from the manufacturing department terminal 1, and stores the obtained actual input performance information 11 (1015).

The production management department server 3 obtains the actual completion performance information 12 from the manufacturing department terminal 1, and stores the obtained actual completion performance information 12 (1016).

The production management department server 3 obtains the actual stocking performance information 21 from the material department terminal 2, and stores the obtained actual stocking performance information 21 (1017).

The production management department server 3 obtains the actual stock retrieval performance information 22 from the material department terminal 2, and stores the obtained actual stock retrieval performance information 22 (1018).

The production management department server 3 obtains actual transport performance information, which is actual performance information about the transportation of a product, from the material department terminal 2 for a warehouse from which the product is retrieved to be shipped to the customer, stores the obtained actual transport performance information (1019), and ends the processing.

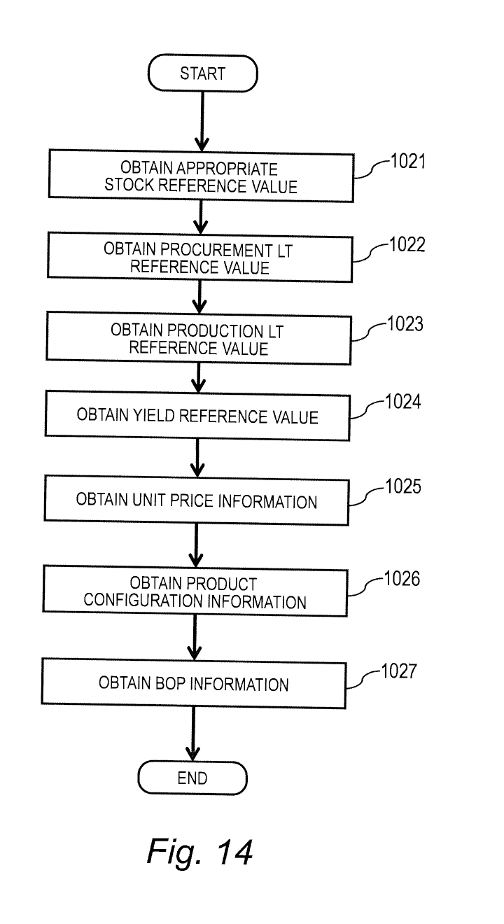

The processing of obtaining a reference value of Step 102 is described next with reference to FIG. 14. FIG. 14 is a flow chart of reference value obtaining processing according to the first embodiment of this invention.

When the reference value obtaining processing is started in Step 102, the production management department server 3 obtains the appropriate stock reference value information 42 from the data storage part 4 (1021). The appropriate stock reference value information 42 is used for a comparison with the stock count of each warehouse which is calculated from the actual stocking performance information 21 and actual stock retrieval performance information 22 of the warehouse. The production management department server 3 can determine how large the discrepancy between the current stock count of the warehouse and the appropriate stock reference value information 42 is in this manner.

The production management department server 3 obtains a material procurement lead time reference value from the various master information 41 of the data storage part 4 (1022). The material procurement lead time reference value is used for a comparison with actual parts procurement lead time performance which is calculated from the actual parts order performance information 60 and the actual parts arrival performance information 70. The production management department server 3 can determine whether or not there is a delay in parts procurement in this manner. When it is determined that parts procurement is delayed, the production management department server 3 can also calculate the length of the delay.

The production management department server 3 obtains a production lead time reference value from the various master information 41 of the data storage part 4 (1023). The production lead time reference value is used for a comparison with actual production lead time performance which is calculated from the actual input performance information 11 and the actual completion performance information 12. The production management department server 3 can determine whether or not there is a delay in production in this manner. When it is determined that production is delayed, the production management department server 3 can also calculate the length of the delay.

The production management department server 3 obtains a yield reference value from the various master information 41 of the data storage part 4 (1024). The yield reference value is set for each product and each manufacturing process. The yield reference value is used for a comparison with a yield that is calculated for each product and each manufacturing process from the actual input performance information 11 and the actual completion performance information 12. The production management department server 3 can thus determine which manufacturing process has a yield that is the cause of failure to match the shipped quantity 503 of the product's shipping request fulfillment information 50 with the requested quantity 403 of the shipping request information 45.

The production management department server 3 obtains unit price information from the various master information 41 of the data storage part 4 (1025). The unit prices of parts, intermediate products, and finished products stored in a warehouse in a storing process are registered as the unit price information. The production management department server 3 calculates an evaluated stock value for each warehouse by multiplying the stock count of the warehouse by the unit price of the unit price information.

The production management department server 3 obtains product configuration information from the various master information 41 of the data storage part 4 (1026). The relation between a product and parts that constitute the product is registered as the product configuration information.

The production management department server 3 obtains the BOP information from the various master information 41 of the data storage part 4 (1027), and ends the processing. The relation between a product and a manufacturing process for manufacturing the product and a storing process for storing the product is registered as the BOP information.

The production management department server 3 uses the product configuration information obtained in Step 1026 and the BOP information obtained in Step 1027 to identify which part in which process is the cause of a delay in product delivery.

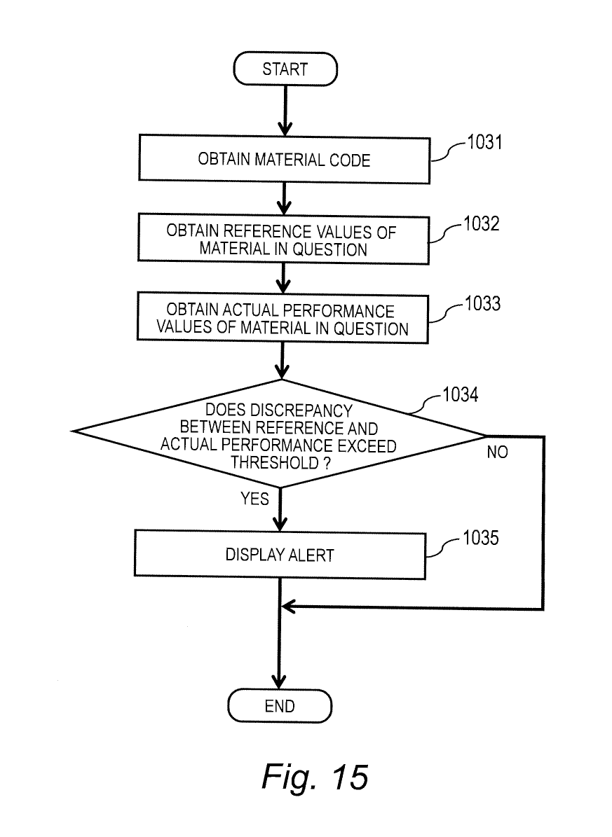

The processing of calculating a discrepancy of Step 103 is described next with reference to FIG. 15. FIG. 15 is a flow chart of discrepancy calculating processing according to the first embodiment of this invention.

When the discrepancy calculating processing is started in Step 103, the production management department server 3 obtains the identifier of a product that is the target of this processing (1031). In Step 1031, the production management department server 3 also identifies parts that constitute the processing target product by referring to the product configuration information, and identifies a manufacturing process and a storing process that the processing target product undergoes before completion by referring to the BOP information.

The production management department server 3 obtains reference values for the respective processes of the processing target product (1032). Specifically, the production management department server 3 obtains the appropriate stock reference value information 42 of the storing process identified in Step 1031 to obtain procurement lead time reference values of the parts identified in Step 1031. The production management department server 3 also obtains a production lead time reference value and a yield reference value for the processing target product and the parts identified in Step 1031 in the manufacturing process identified in Step 1031.

The production management department server 3 obtains actual performance information of the respective processes of the processing target product. Specifically, the production management department server 3 obtains actual parts procurement lead time performance, actual production lead time performance, the yield, and the stock count.

Actual parts procurement lead time performance is calculated for each of the parts identified in Step 1031 by subtracting a date (including the year) that is registered as the order date 604 of the actual parts order performance information 60 for the identified part from a date (including the year) that is registered as the arrival date 704 of the actual parts arrival performance information 70 for the identified part.

How to obtain actual production lead time performance is described. The production management department server 3 searches the actual completion performance information 12 for an entry in which the product 901 matches the identifier of the processing target product and the line 902 matches the identifier of the manufacturing process identified in Step 1031, and obtains a date (including the year) registered as the completion date 904 in the entry (the completion date). The production management department server 3 also searches the actual input performance information 11 for an entry in which the product 801 matches the identifier of the processing target product and the line 802 matches the identifier of the manufacturing process identified in Step 1031, and obtains a date (including the year) registered as the input date 804 in the entry (the order date). The production management department server 3 subtracts the obtained order date from the obtained completion date, thereby obtaining actual production lead time performance.

How to obtain the yield is described. The production management department server 3 searches the actual input performance information 11 for an entry in which the product 801 matches the identifier of the processing target product and the line 802 matches the identifier of the manufacturing process identified in Step 1031, and obtains a value registered as the input quantity 803 in the entry (the input quantity). The production management department server 3 also searches the actual completion performance information 12 for an entry in which the product 901 matches the identifier of the processing target product and the line 902 matches the identifier of the manufacturing process identified in Step 1031, and obtains a value registered as the completed quantity 903 in the entry (the completed quantity). The production management department server 3 divides the obtained completed quantity by the obtained input quantity, thus obtaining the yield.

How to obtain the stock count is described. For each of the parts identified in Step 1031, the production management department server 3 searches the actual stocking performance information 21 for an entry in which the part 1001 matches the identifier of identified part, and searches the actual stock retrieval performance information 22 for every entry in which the part 1101 matches the identifier of the identified part. From the found entries of the actual stock retrieval performance information 22, the production management department server 3 obtains an entry in which an identifier registered as the warehouse 1102 matches the warehouse identifier of the found entry of the actual stocking performance information 21 and the stock retrieval date 1104 is equal to or later than the stocking date 1004. The production management department server 3 subtracts a value registered as the retrieved stock quantity 1103 in the obtained entry of the actual stock retrieval performance information 22 from a value registered as the stocked quantity 1003 in the found entry of the actual stocking performance information 21, to thereby obtain the stock count of the part for each warehouse.

The production management department server 3 next compares the actual performance values obtained in Step 1033 against the reference values obtained in Step 1032 to calculate a discrepancy between the actual performance values and the reference values, and determines whether or not the calculated discrepancy is within a threshold (1034). The threshold may be set in the parameter information 46 in advance, or a value that is set in advance and then changed by the administrator of the production management department server 3 or the like.

Specifically, the production management department server 3 calculates for each part a discrepancy between actual parts procurement lead time performance and the parts procurement lead time reference value, calculates for each manufacturing process a discrepancy between actual production lead time performance and the production lead time reference value, calculates for each manufacturing process a discrepancy between the yield and the yield reference value, and calculates for each storing process a discrepancy between the stock count and the appropriate stock reference value information 42. When at least one of the discrepancies is outside the threshold, the production management department server 3 determines that the overall discrepancy is outside the threshold, and determines that the overall discrepancy is within the threshold when all of the discrepancies are within the threshold.

When it is determined in Step 1034 that the discrepancy is outside the threshold, the production management department server 3 generates the alert display screen 1600 to display an alert (1035), and ends the processing. Details of the alert display screen 1600 are described with reference to FIG. 16.

When it is determined in Step 1034 that the discrepancy is inside the threshold, the production management department server 3 ends the processing.

The alert display screen 1600 is described next with reference to FIG. 16. FIG. 16 is an explanatory diagram of the alert display screen 1600 according to the first embodiment of this invention.

The alert display screen 1600 is a screen for viewing at a glance the entire supply chain from parts delivery by suppliers to product shipping to customers. The alert display screen 1600 includes sections for a supplier 1601, a manufacturing process 1602, a warehouse (storing process) 1603, and a shipping destination 1604. The supply chain is expressed by connecting the flow of a part or a product between these sections by a line.

The section for the supplier 1601 displays a delivery date observance rate for each of Parts 1 to 7. The delivery date observance rate is calculated for each part by referring to the actual parts arrival performance information 70 to calculate the total arrival quantity of the part and divide the arrival quantity for which the arrival date 704 is past the due delivery date by the total arrival quantity.

The section for the manufacturing process 1602 displays for each manufacturing process the operating rate, the yield, and the schedule observance rate.

How to calculate the operating rate displayed in the section for the manufacturing process 1602 is described. The operating rate is the proportion of the count of machines that can be put into operation to the count of all machines for use in a manufacturing process. The manufacturing department terminal 1 stores the count of machines that can be put into operation in its associated manufacturing process as actual operating performance information, and the production management department server 3 stores for each manufacturing process the count of all machines for use in the manufacturing process in the BOP information. The production management department server 3 obtains the actual operating performance information from the manufacturing department terminal 1, and calculates the operating rate by dividing the count of machines that can be put into operation according to the obtained actual operating performance information by the count of all machines for use in a manufacturing process that is associated with the obtained actual operating performance information.

How to calculate the yield displayed in the section for the manufacturing process 1602 is described next. The production management department server 3 refers to the actual completion performance information 12 to calculate for each manufacturing process the total value of the completed quantity 903, and also refers to the actual input performance information 11 to calculate for each manufacturing process the total value of the input quantity 803. The production management department server 3 divides the calculated total value of the completed quantity 903 by the calculated total value of the input quantity 803, thus calculating the yield in the manufacturing process.

How to calculate the schedule observance rate displayed in the section for the manufacturing process 1602 is described next. The schedule observance rate of a manufacturing process is the proportion of the count of products for which the production lead time of the manufacturing process is within a period defined by a preset schedule (a scheduled period) to the count of products completed in the manufacturing process.

Specifically, the production management department server 3 refers to the actual completion performance information 12 to calculate for each manufacturing process the total value of the completed quantity 903 (the overall sum). The production management department server 3 also calculates the production lead time by subtracting the input date 804 of the actual input performance information 11 from the completion date 904 of the actual completion performance information 12, and calculates the total value of the completed quantity 903 for which the calculated production lead time is within the scheduled period of the manufacturing process (the schedule observance sum). The production management department server 3 divides the calculated schedule observance sum by the calculated overall sum, thus calculating the schedule observance rate of the manufacturing process. The scheduled period of each manufacturing process can be registered in, for example, the parameter information 46.

The section for the warehouse (storing process) 1603 displays for each storing process the stock count of the relevant warehouse and the monetary value of the stocks.

The stock count displayed in the section for the warehouse (storing process) 1603 is calculated for each warehouse by the production management department server 3 by subtracting the retrieved stock count 1103 of the actual stock retrieval performance information 22 from the stocked quantity 1003 of the actual stocking performance information 21. The stock monetary value displayed in the section for the warehouse (storing process) 1603 is calculated by multiplying the stock count by a unit price that is registered in the unit price information.

The section for the shipping destination 1604 displays for each shipping destination the delivery date observance rate. How to calculate the delivery date observance rate displayed in the section for the shipping destination 1604 is described. The production management department server 3 refers to the shipping request fulfillment information 50 to calculate for each shipping destination the total value of the shipped quantity 503 (the overall sum). The production management department server 3 also calculates for each shipping destination the total value of the shipped quantity 503 for which the shipping date 504 of the shipping request fulfillment information 50 is equal to or earlier than the requested delivery date 404 of the shipping request information 45 (the delivery date observance sum). The production management department server 3 divides the delivery date observance sum by the overall sum, thus calculating the delivery date observance rate with respect to the shipping destination.

The production management department server 3 calculates, for the delivery date observance rate in the section for the supplier 1601, the operating rate, the yield, and the schedule observance rate in the section for the manufacturing process 1602, the stock count and the stock monetary value in the section for the warehouse 1603, and the delivery date observance rate in the section for the shipping destination 1604, discrepancies from their respective associated reference values. In FIG. 16, discrepancies of the stock count and stock monetary value of an intermediate product stock from their reference values are each outside the threshold, and this intermediate product stock is displayed in a manner that indicates an alert as illustrated by a frame 1605. The discrepancy of the delivery date observance rate with respect to Shipping Destination 1 from its reference value is also outside the threshold in FIG. 16, and Shipping Destination 1 is displayed in a manner that indicates an alert as illustrated by a frame 1606. Specifically, the actual performance value of the delivery date observance rate with respect to Shipping Destination 1 is 85% and lower than the reference value of the delivery date observance rate for Shipping Destination 1, which is 90%, by an amount equal to or more than the threshold. Shipping Destination 1 is therefore displayed in a manner that indicates an alert. The difference between the stock count of a storing process for shipping an intermediate product to Shipping Destination 1 and its reference value is outside the threshold, and the stock of this intermediate product is also displayed in a manner that indicates an alert. With the alert display screen 1600 of FIG. 16 which displays the entire supply chain of a product as described above, the administrator can easily understand that an alert is displayed for Shipping Destination 1 because the stock count in a storing process for shipping an intermediate product to Shipping Destination 1 is less than the reference value. Displaying actual performance values of processes and the like along the entire supply chain of a product thus enables the administrator to easily grasp which process is the cause of a delivery delay or the like.

In FIG. 16, displaying an alert is carried out by displaying the intermediate product stock and Shipping Destination 1 in frames thicker than other frames. However, this invention is not limited thereto. An element to be displayed in a manner that indicates an alert only needs to be displayed so that the element is distinguishable from other elements by, for example, using a different color or shape for the frame of the alert display element than the frames of other elements.

When the intermediate product stock displayed in a manner that indicates an alert is selected on the alert display screen 1600 of FIG. 16, the appropriate stock details screen 1700 that contains detailed information of the selected intermediate product stock is displayed. FIG. 17 is an explanatory diagram of the appropriate stock details screen 1700 according to the first embodiment of this invention.

The appropriate stock details screen 1700 includes an item-by-item stock list 1701 and a section for a stocking capacity filling rate 1702. The item-by-item stock list 1701 is a list of the stock counts, reference values, and the like of products (items) stored in the warehouse of the selected intermediate product stock that is organized by product, and includes columns for an item 1703, a stock count 1704, and an acceptable fluctuation range 1705.

The column for the item 1703 displays the identifier of a product stored in the warehouse of the selected intermediate product stock.

The column for the stock count 1704 displays the current stock count for each product of the selected intermediate product stock, and displays a reference value for each product type of the selected intermediate product stock.

The column for the acceptable fluctuation range 1705 displays the acceptable fluctuation ranges of reference values for products of the selected intermediate product stock out of reference values registered in the appropriate stock reference value information 42. A product whose current stock count is within the acceptable fluctuation range of its reference value does not constitute a target of alert display, and a product whose current stock count is outside the acceptable fluctuation range of its reference value is displayed in a manner that indicates an alert.

The section for the stocking capacity filling rate 1702 displays, in a graph format, the proportion of the current stock count of each product type to a reference value.

In FIG. 17, the stock count “30” of an item A is smaller than “190”, which is a lower limit reference value calculated by subtracting an acceptable fluctuation range “10” from a reference value “200”. The item A is therefore a target of alert display. The stock count “300” of an item B is smaller than “580”, which is a lower limit reference value calculated by subtracting an acceptable fluctuation range “20” from a reference value “600”. The item B, too, is therefore a target of alert display. Entries of the item A and the item B on the appropriate stock details screen 1700 are accordingly displayed enclosed in a dotted-line frame on the appropriate stock details screen 1700 of FIG. 17 as a way to indicate an alert.

In the case where the item A is selected on the appropriate stock details screen 1700 at this point, the production management department server 3 displays a preceding actual performance details screen 1710 to display the actual day-to-day completion performance of the item A in Process 1, which is a process immediately before the storing process selected on the alert display screen 1600 of the item A.

Processing of displaying the preceding actual performance details screen 1710 is described.

The production management department server 3 first refers to the BOP information to identify a manufacturing process that immediately precedes the storing process selected on the alert display screen 1600 of the item A (Process 1). The production management department server 3 next refers to the actual completion performance information 12 to obtain the completed quantity 903 and the completion date 904 from an entry in which an identifier registered as the product 901 matches the identifier of the item A and an identifier registered as the line 902 matches the identified Process 1. The production management department server 3 also obtains a reference value for the item A in the identified Process 1. The production management department server 3 displays, in a graph format, the completed quantity 903 of each obtained completion date 904 and displays the obtained reference value, thus displaying the preceding actual performance details screen 1710.

The administrator can know that the completed quantity is less than the reference value on January 12 and January 13 by referring to the preceding actual performance details screen 1710 of FIG. 17. The administrator can further investigate what happened in Process 1 on January 12 and January 13. For example, in the case where January 12 is selected on the preceding actual performance details screen 1710, the production management department server 3 may display the yield of the item A in Process 1 that has “January 12” as the completion date, in order to assist the administrator with the investigation.

The production management department server 3 thus displays more detailed actual performance information of a process when the process is selected, thereby assisting the administrator with what is called drill-down analysis. The administrator can therefore understand the cause of an alert with ease by selecting an element that is displayed in a manner that indicates an alert.

The administrator can also track the cause of an alert back to the upstream because, when a storing process is selected, the production management department server 3 displays actual performance information of a manufacturing process that immediately precedes the selected storing process.

The appropriate stock details information 1700 of FIG. 17 is displayed when an intermediate product stock (1605) is selected in FIG. 16. Alternatively, the production management department server 3 may display, when one of the manufacturing processes in the section for the manufacturing process 1602 of FIG. 16 is selected, a details screen that contains item-by-item actual performance values and reference values of the selected manufacturing process. In the case where an item is selected on the details screen, the production management department server 3 may display an actual performance value of a process that immediately precedes the manufacturing process (a process for delivery from a supplier or a process for storing an intermediate product stock).

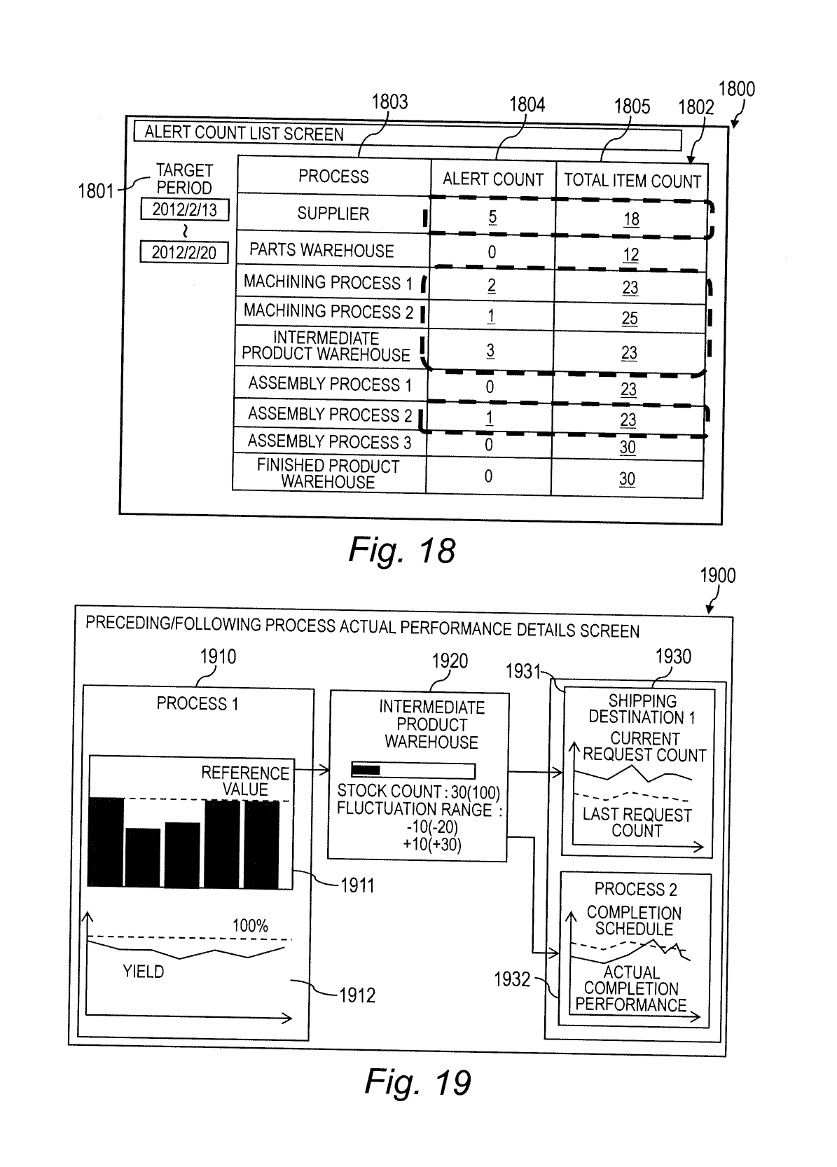

FIG. 18 is an explanatory diagram of an alert display screen 1800 according to a modification example of the first embodiment of this invention.

The alert display screen 1600 of FIG. 16 is a screen for helping the administrator understand for which process in the entire supply chain an alert is issued. The alert display screen 1800 of this modification example which is illustrated in FIG. 18, on the other hand, is a screen that compiles alerts that have been issued quantitatively on a process-by-process basis.

The alert display screen 1800 of this modification example includes a field for a target period 1801 and an alert count list 1802.

The period of actual performance information or the like that is compiled for the purpose of displaying an alert is entered in the field for the target period 1801, where the entered period is displayed.

The alert count list 1802 includes columns for a process 1803, an alert count 1804, and a total item count 1805.

The column for the process 1803 displays all processes that are managed by the production management department server 3. The production management department server 3 refers to the BOP information to obtain all processes managed by the production management department server 3, and displays the obtained processes in the column for the process 1803.

The column for the alert count 1804 displays for each process the count of product types for which the discrepancy between an actual performance value and a reference value is equal to or greater than a threshold. The column for the total item count 1805 displays for each process the count of product types handled in the process. A link is attached to each count displayed in the column for the alert count 1804 so that detailed information of a selected process such as the appropriate stock details screen 1700 of FIG. 17 is displayed by selecting a count displayed in the column for the alert count 1804.

How the production management department server 3 calculates values to be displayed in the columns for the alert count 1804 and the total item count 1805 is described. The production management department server 3 refers to actual performance information of a period entered in the field for the target period 1801 to calculate actual performance values associated with the respective processes. Actual performance values associated with the respective processes are, as described with reference to FIG. 16, a delivery date observance rate in the case of a supplier process and an operating rate, a yield, and a schedule observance rate in the case of a manufacturing process. The production management department server 3 calculates for each process the count of product types for which the discrepancy between a calculated actual performance value and a reference value associated with the actual performance value is outside the threshold, and displays the calculated count in the column for the alert count 1804. The production management department server 3 refers to the actual performance information of the respective processes of the period which is entered in the field for the target period 1801 to calculate for each process the count of product types handled in the process, and displays the calculated count in the column for the total item count 1805.

### Second Embodiment

A second embodiment of this invention is described next with reference to FIG. 19.

In this embodiment, a preceding/following process actual performance details screen 1900 is displayed instead of the appropriate stock details screen 1700 of the first embodiment which is illustrated in FIG. 17. FIG. 19 is an explanatory diagram of the preceding/following process actual performance details screen 1900 according to the second embodiment of this invention.

When an item is selected on the appropriate stock details screen 1700, the preceding actual performance details screen 1710 for displaying day-to-day actual completion performance of a manufacturing process immediately before the selected process is displayed in FIG. 17. In this embodiment, the preceding/following process actual performance details screen 1900 is displayed which contains actual performance information of a manufacturing process that immediately precedes a selected process and actual performance information of a process that immediately follows the selected process.

The preceding/following process actual performance details screen 1900 includes a preceding process actual performance display area 1910, a selected process actual performance display area 1920, and a following process actual performance display area 1930.

The preceding process actual performance display area 1910 displays actual performance information of a process that immediately precedes a process selected on the alert display screen 1600 of FIG. 16 or the alert display screen 1800 of FIG. 18. The preceding process actual performance display area 1910 of FIG. 19 includes, for example, an actual completion performance display area 1911 of a manufacturing process and a yield display area 1912 of the manufacturing process. The actual completion performance display area 1911 displays, in a graph format, the day-to-day completed quantity of the manufacturing process and a reference value of the manufacturing process. The yield display area 1912 displays, in a graph format, the day-to-day yield in the manufacturing process.

The selected process actual performance display area 1920 displays the stock count and reference value of a process (storing process) selected on the alert display screen 1600 of FIG. 16 or the alert display screen 1800 of FIG. 18. Specifically, the selected process actual performance display area 1920 displays a current stock count “30” and a current reference value “100”, and displays “−20” and “+30” as a current acceptable fluctuation range. An area next to the current acceptable fluctuation range is an acceptable fluctuation range modification area, where “−10” and “+10” are entered as a modified acceptable fluctuation range and where the modified acceptable fluctuation range is displayed.

The following process actual performance display area 1930 displays actual performance information and the like of a process that immediately follows a process selected on the alert display screen 1600 of FIG. 16 or the alert display screen 1800 of FIG. 18. The following process actual performance display area 1930 of FIG. 19 includes a shipping destination actual performance display area 1931 and a process actual performance display area 1932.

The shipping destination actual performance display area 1931 displays a current request count, which indicates the count of products requested by Shipping Destination 1 in the current period, and a last request count, which indicates the count of products requested by Shipping Destination 1 in the last period.

How the production management department server 3 calculates the current request count is described. The production management department server 3 refers to the shipping request information 45 to obtain the requested quantity 403 from every entry in which the shipping destination 401 matches the identifier of Shipping Destination 1, the requested product 402 matches a product type selected on the appropriate stock details screen 1700 of FIG. 17, and the request reception date 405 is within the current target period. The production management department server 3 displays the obtained requested quantity 403 in chronological order of the request reception date 405 in a graph format in the shipping destination actual performance display area 1931 as the current request count.

How the production management department server 3 calculates the last request count is described next. The production management department server 3 refers to the shipping request information 45 to obtain the requested quantity 403 from every entry in which the shipping destination 401 matches the identifier of Shipping Destination 1, the requested product 402 matches a product type selected on the appropriate stock details screen 1700 of FIG. 17, and the request reception date 405 is within a given period prior to the current target period. The production management department server 3 displays the obtained requested quantity 403 in chronological order of the request reception date 405 in a graph format in the shipping destination actual performance display area 1931 as the last request count.

The production management department server 3 determines whether or not the current request count is higher than the last request count and, when the current request count is higher than the last request count, displays a suggestion to modify the reference value registered for the intermediate product stock in the appropriate stock reference value information 42 so that the reference value increases. In this manner, when the current request count in the shipping destination actual performance display area 1931 is higher than the last request count, which means that the demand for the intermediate product from the shipping destination in question has risen, the administrator can arrange an increase in the stock count of the intermediate product by modifying the reference value for the intermediate product stock so that the reference value increases.

When the current request count is lower than the last request count, on the other hand, the production management department server 3 displays a suggestion to modify the reference value registered for the intermediate product stock so that the reference value decreases. When the current request count in the shipping destination actual performance display area 1931 is lower than the last request count, which means that the demand for the intermediate product from the shipping destination in question has dropped, the administrator arranges a decrease in the stock count of the intermediate product by modifying the reference value for the intermediate product stock so that the reference value decreases.

The administrator can thus determine whether a shipping destination's demand has risen or dropped by referring to the shipping destination actual performance display area 1931, and set an appropriate stock reference value. As opposed to conventional technologies with which detailed information of a shipping destination process and a manufacturing process that follow a storing process is not displayed and the administrator accordingly has difficulties in deriving an appropriate stock reference value, this embodiment enables the administrator to derive an appropriate stock reference value with ease.

The process actual performance display area 1932 displays a completion schedule and actual completion performance of a manufacturing process (Process 2) that immediately follows a process selected on the alert display screen 1600 of FIG. 16 or the alert display screen 1800 of FIG. 18.

The completion schedule is the count of articles scheduled to be completed in Process 2 that belong to a product type selected on the appropriate stock details screen 1700 of FIG. 17, and the count is registered in the line input schedule information 43. The actual completion performance is the count of articles completed in Process 2 that belong to a product type selected on the appropriate stock details screen 1700 of FIG. 17, and the count is registered in the actual completion performance information 12.

The production management department server 3 determines whether or not a value of the actual completion performance is larger than a value of the completion schedule and, when the value of the actual completion performance is smaller than the value of the completion schedule, displays a suggestion to modify the reference value registered for the intermediate product stock in the appropriate stock reference value information 42 so that the reference value increases. In this manner, when the actual completion performance displayed in the process actual performance display area 1932 is less than the completion schedule, the administrator can arrange an increase in the stock count of the intermediate product by modifying the reference value for the intermediate product stock so that the reference value increases.

When the value of the actual completion performance is larger than the value of the completion schedule, on the other hand, the production management department server 3 displays a suggestion to modify the reference value registered for the intermediate product stock in the appropriate stock reference value information 42 so that the reference value decreases. In this manner, when the actual completion performance displayed in the process actual performance display area 1932 is greater than the completion schedule, the administrator arranges a decrease in the stock count of the intermediate product by modifying the reference value for the intermediate product stock so that the reference value decreases. The administrator can thus determine actual performance of a manufacturing process that immediately follows a storing process by referring to the process actual performance display area 1932, and set an appropriate stock reference value.

### Third Embodiment

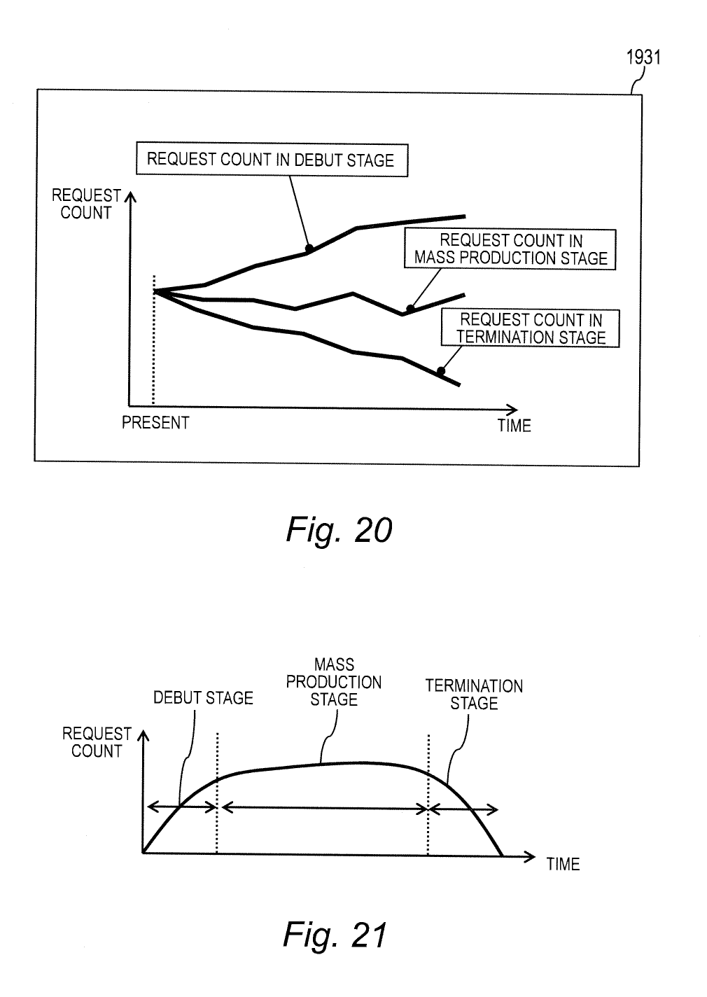

A third embodiment of this invention is described next with reference to FIGS. 20 and 21.

In this embodiment, only the current request count is displayed in the shipping destination actual performance display area 1931 of the second embodiment, the stage in life cycle of a product is determined based on the current request count, and a suggestion to modify the appropriate stock reference value information 42 in a manner that suits the determined stage in life cycle is displayed.

FIG. 20 is an explanatory diagram of the shipping destination actual performance display area 1931 according to the third embodiment of this invention. FIG. 21 is an explanatory diagram of a transition in shipping request count according to the third embodiment of this invention.

As illustrated in FIG. 21, the life cycle of a product is divided into three stages: a debut stage, a mass production stage, and a termination stage, based on the transition in shipping request count which is the count of pieces of a product that are requested to be shipped by a shipping destination. The shipping request count in the debut stage tends to increase and the chance of stock running out is high. The shipping request count in the termination stage tends to decrease and the chance of overstocking is high.

Accordingly, the production management department server 3 displays the current request count in the shipping destination actual performance display area 1931 of FIG. 20. When the current request count is on the rise, the production management department server 3 determines that the stage in life cycle of the product in question is the debut stage, and displays a suggestion to modify the lower limit value of the acceptable fluctuation range so as to close the gap between a reference value for a warehouse from which the product is shipped to the shipping destination in question and the lower limit value of the acceptable fluctuation range, and thus prevent stocks in the warehouse from running out. In this manner, when finding out that the current request count is on the rise by referring to the shipping destination actual performance display area 1931, the administrator modifies the lower limit of the acceptable fluctuation range so as to close the gap between the reference value for the warehouse and the lower limit value of the acceptable fluctuation range.

When the current request count is on the downward slope, on the other hand, the production management department server 3 determines that the product is at the termination stage in its life cycle, and displays a suggestion to modify the upper limit value of the acceptable fluctuation range so as to close the gap between a reference value for a warehouse from which the product is shipped to the shipping destination in question and the upper limit value of the acceptable fluctuation range, and thus prevent overstocking the warehouse. In this manner, when finding out that the current request count is on the downward slope by referring to the shipping destination actual performance display area 1931, the administrator modifies the upper limit of the acceptable fluctuation range so as to close the gap between the reference value for the warehouse and the upper limit value of the acceptable fluctuation range.

The administrator can thus set a stock reference value appropriately based on the stage in life cycle of a product.

### Fourth Embodiment

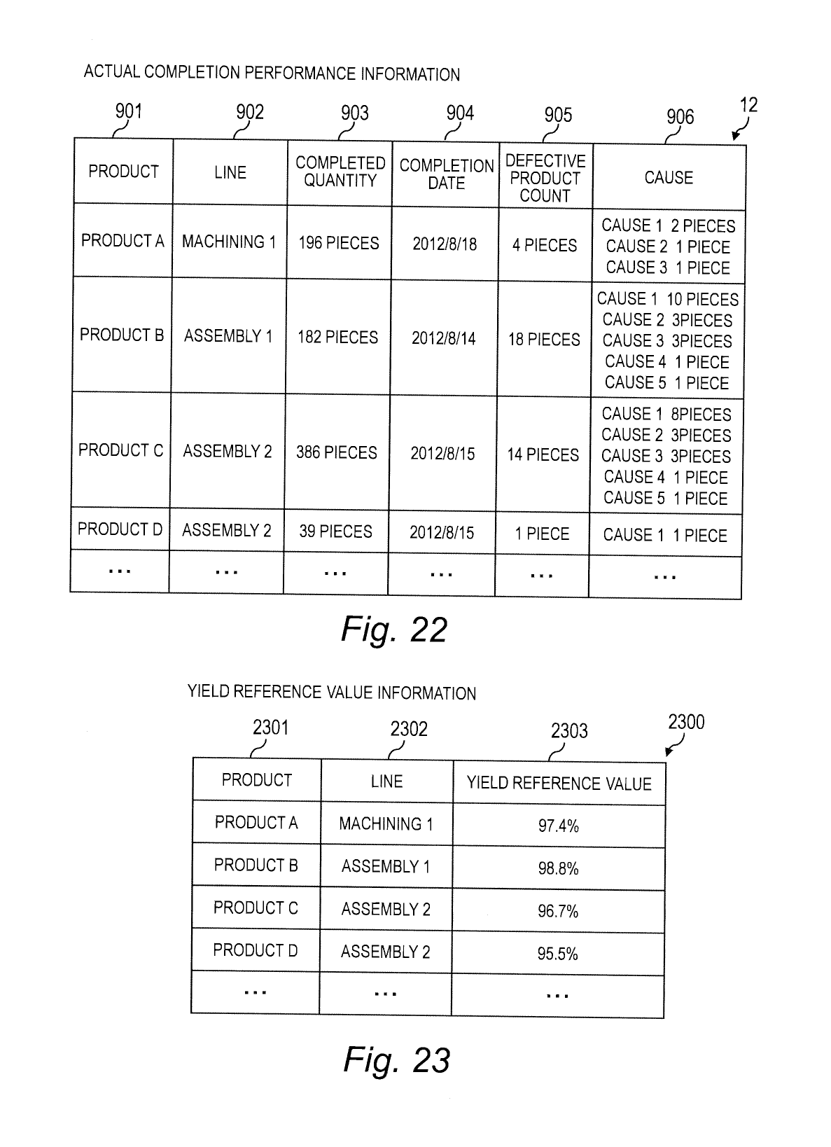

A fourth embodiment of this invention is described next with reference to FIGS. 22 to 24.

The preceding actual performance details screen 1710 of the first embodiment displays day-to-day actual completion performance in a graph format. The preceding actual performance details screen 1710 of this embodiment, on the other hand, displays the day-to-day yield in a graph format.

FIG. 22 is an explanatory diagram of the actual completion performance information 12 according to the fourth embodiment of this invention.

The actual completion performance information 12 of FIG. 22 includes a product 901, a line 902, a completed quantity 903, a completion date 904, a defective product count 905, and a cause 906. The product 901, the line 902, the completed quantity 903, and the completion date 904 in FIG. 22 are the same as those in the actual completion performance information 12 of FIG. 9, and are denoted by the same reference symbols in order to omit their descriptions here.

Registered as the defective product count 905 is a count that is obtained by subtracting the count of completed pieces of the product from the count of input pieces of the product. Specifically, the completed quantity 903 of an entry in the actual completion performance information 12 is subtracted from the input quantity 803 of a corresponding entry in the actual input performance information 11, and the resultant count is registered as the defective product count 905. An entry in the actual input performance information 11 that corresponds to an entry in the actual completion performance information 12 is an entry in which the product 801 matches the product 901 and the line 802 matches the line 902.

The causes of the defective products and the count of pieces of the product that have been made defective by those causes are registered as the cause 906.

FIG. 23 is an explanatory diagram of yield reference value information 2300 according to the fourth embodiment of this invention.

The yield reference value information 2300 includes a product 2301, a line 2302, and a yield reference value 2303.

Registered as the product 2301 is the identifier of a product for which a manufacturing process has been completed. The identifier of the manufacturing process that has been completed is registered as the line 2302. A reference value for the yield is registered as the yield reference value 2303.

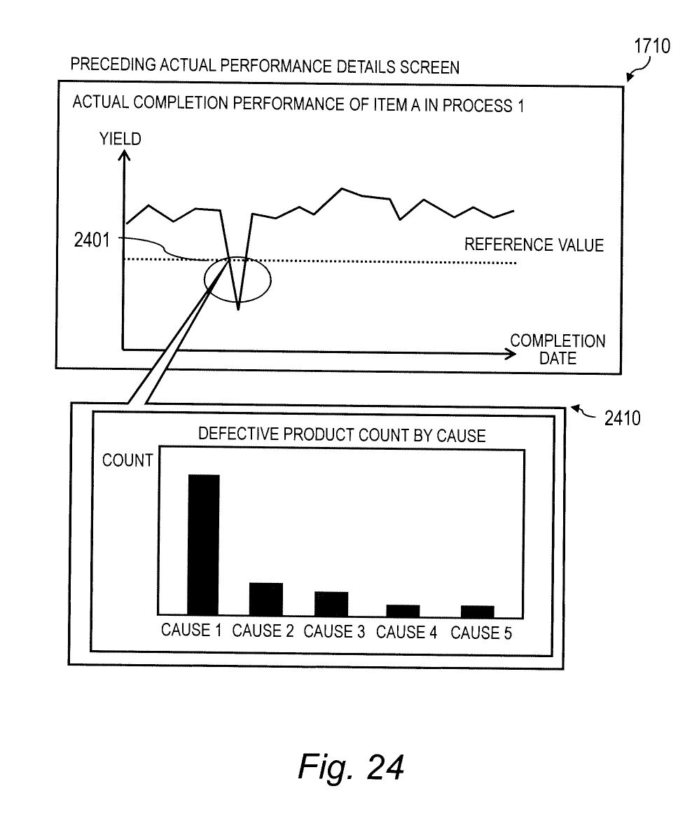

FIG. 24 is an explanatory diagram of the preceding actual performance details screen 1710 according to the fourth embodiment of this invention.

The preceding actual performance details screen 1710 of this embodiment displays, as actual performance information, the day-to-day yield of the item A in Process 1, which is immediately before a storing process selected on the alert display screen 1600 of FIG. 16 or the alert display screen 1800 of FIG. 18. The item A is a product selected on the appropriate stock details screen 1700. The production management department server 3 refers to the yield reference value information 2300 to obtain a reference value that is registered as the yield reference value 2303 in association with Process 1 and the item A, and displays the obtained reference value on the preceding actual performance details screen 1710.

An area 2401 in which the yield is less than the reference value is selected here on the preceding actual performance details screen 1710. When the area 2401 is selected, the production management department server 3 refers to the actual completion performance information 12 of FIG. 22 and displays a cause-by-cause defective product count display screen 2410.

Specifically, the production management department server 3 obtains from the actual performance information 12 an entry in which the product 901 is the item A, the line 902 is Process 1, and the completion date 904 is a date (including the year) that falls within the period of the selected area 2401. The production management department server 3 refers to the cause 906 of the obtained entry, and displays the causes of defective products and the counts of pieces of the product that have been made defective by those causes on the cause-by-cause defective product count display screen 2410, in descending order of the defective product count.

This enables the administrator to visually identify the cause of the yield being equal to or less than the reference value, and facilitates the planning of a countermeasure.

### Fifth Embodiment

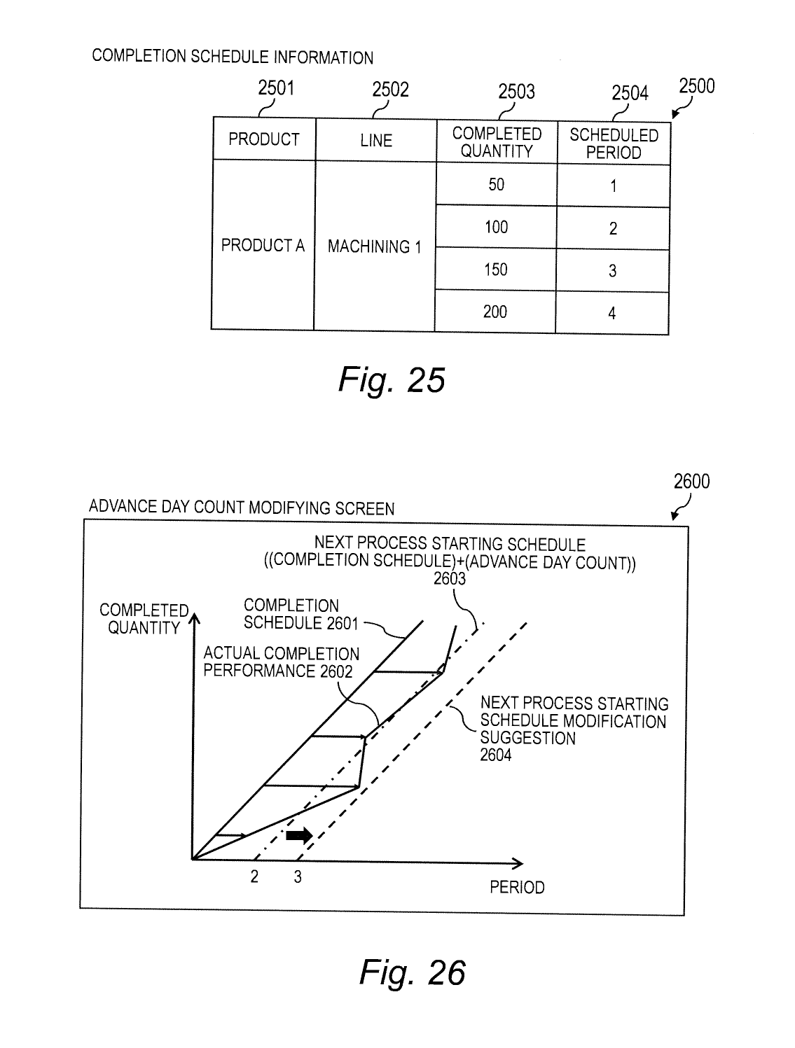

A fifth embodiment of this invention is described next with reference to FIGS. 25 to 29.

In this embodiment, when a screen for displaying actual performance information of a manufacturing process is to be displayed, an advance day count modifying screen 2600 (illustrated in FIG. 26 and other drawings) is displayed which is used to modify the count of advance days for adjusting the time schedule for starting a process subsequent to the manufacturing process. The screen for displaying actual performance information of a manufacturing screen is displayed when a manufacturing process is selected on the alert display screen 1600 of FIG. 16 or the alert display screen 1800 of FIG. 18 and a product is selected on a details screen of the manufacturing process, or when a manufacturing process is selected on the alert display screen 1600 of FIG. 16 or the alert display screen 1800 of FIG. 18 and a product is selected on the appropriate stock details screen 1700 of FIG. 17, which causes the preceding actual performance details screen 1710 to be displayed.

FIG. 25 is an explanatory diagram of completion schedule information 2500 according to the fifth embodiment of this invention.

The completion schedule information 2500 is stored in the data storage part 4 of the production management department server 3. For each manufacturing process of a product, the completed quantity and the count of days required to complete as many pieces of the product as the completed quantity are registered in the completion schedule information 2500.

The completion schedule information 2500 includes a product 2501, a line 2502, a completed quantity 2503, and a scheduled period 2504.

The identifier of a product is registered as the product 2501. The identifier of a manufacturing process that the product undergoes is registered as the line 2502.

Registered as the completed quantity 2503 is the quantity of pieces of the product to be completed in the manufacturing process that is identified by the identifier registered as the line 2502. A period in which as many pieces of the product as the quantity registered as the completed quantity 2503 are planned to be completed is registered as the scheduled period 2504.

FIG. 26 is an explanatory diagram of an advance day count modifying screen 2600 according to the fifth embodiment of this invention.

The advance day count modifying screen 2600 displays a completion schedule 2601, actual completion performance 2602, and a next process starting schedule 2603 in a graph format with period shown on the horizontal axis and completed quantity shown on the vertical axis.

How to display the completion schedule 2601 is described. The production management department server 3 first searches the completion schedule information 2500 for an entry in which the product 2501 matches the identifier of a product that is a display target and the line 2502 matches the identifier of a manufacturing process that is a display target, and plots a count registered as the completed quantity 2503 of the entry and a period registered as the scheduled period 2504 of the entry on the advance day count modifying screen 2600. The production management department server 3 connects the plotted points by a line, thereby displaying the completion schedule 2601.

How to display the actual completion performance 2602 is described next. The production management department server 3 first searches the actual completion performance information 12 for an entry in which the product 901 matches the identifier of the display target product and the line 902 matches the identifier of the display target manufacturing process, and obtains a count registered as the completed quantity 903 in the entry. The production management department server 3 also obtains a date (including the year) registered as the completion date 904 in the entry of the actual completion performance information 12, and calculates a period by subtracting, from the obtained date (including the year), a date (including the year) that is registered as the input date 804 in an entry of the actual input performance information 11 that corresponds to the entry of the actual completion performance information 12. The production management department server 3 plots the count registered as the obtained completed quantity 903 and the calculated period on the advance day count modifying screen 2600. The production management department server 3 connects the plotted points by a line, thereby displaying the actual completion performance 2602.

How to display the next process starting schedule 2603 is described next. The production management department server 3 calculates the next process starting schedule 2603 by adding an advance day count to the completion schedule 2601. The production management department server 3 displays the calculated next process starting schedule 2603 on the advance day count modifying screen 2600. The advance day count is calculated based on the display target product and the production lead time of the display target manufacturing process. The advance day count is a period in which the completed quantity of the next process starting schedule 2603 is 0 on the advance day count modifying screen 2600.

The production management department server 3 determines whether or not there is a point at which the period of the actual completion performance 2602 exceeds the period of the next process starting schedule 2603. In the advance day count modifying screen 2600 of FIG. 26, the production management department server 3 determines that the period of the actual completion performance 2602 exceeds the period of the next process starting schedule 2603 at some points. The production management department server 3 in this case displays a next process starting schedule modification suggestion 2604 which makes sure that the period of the actual completion performance 2602 does not exceed the period of the next process starting schedule 2603. The next process starting schedule modification suggestion 2604 displayed in FIG. 26 suggests changing the advance day count to “3”.

When the next process starting schedule modification suggestion 2604 is selected by the administrator, the production management department server 3 sets the advance day count of the next process starting schedule modification suggestion 2604 as a new advance day count. This facilitates the administrator's work for adjusting the advance day count.

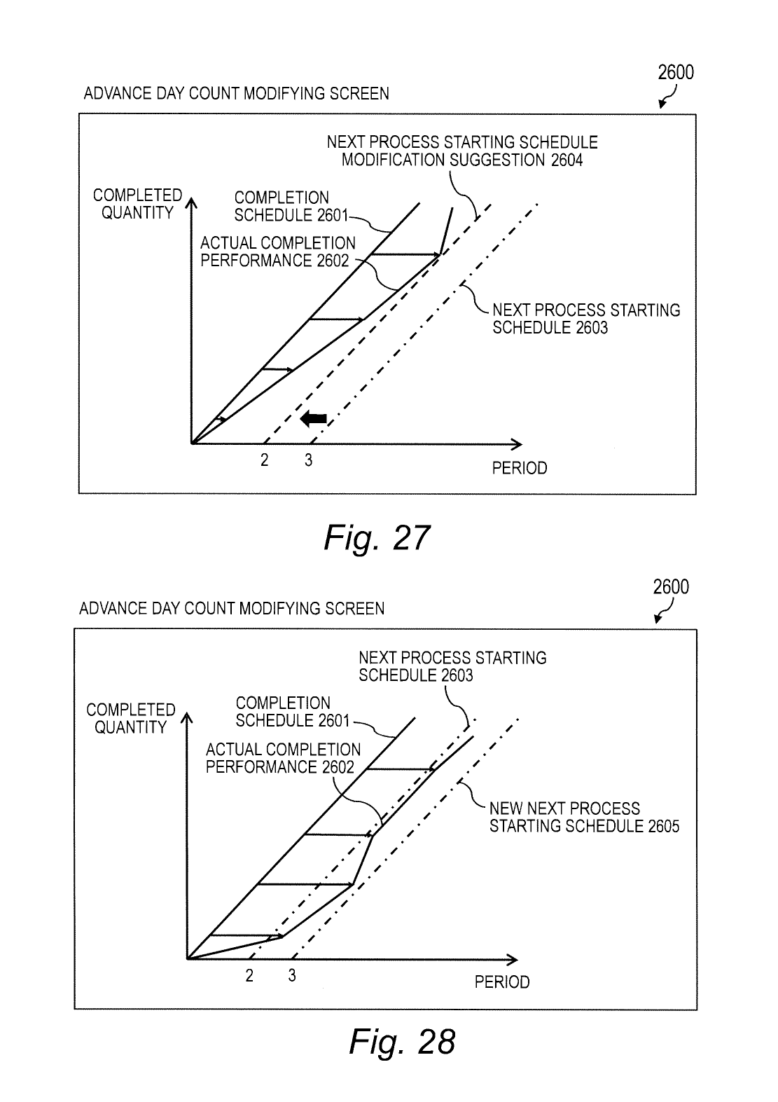

FIG. 27 is an explanatory diagram of the next process starting schedule modification suggestion 2604 according to the fifth embodiment of this invention that is displayed in the case where the period of the actual completion performance 2602 never exceeds the period of the next process starting schedule 2603.

In the case where it is determined that the period of the actual completion performance 2602 exceeds the period of the next process starting schedule 2603 at no point, the production management department server 3 displays the next process starting schedule modification suggestion 2604 that makes the period of the actual completion performance 2602 a minimum period that does not exceed the period of the next process starting schedule 2603. The next process starting schedule modification suggestion 2604 displayed in FIG. 27 suggests changing the advance day count to “2”.

When the next process starting schedule modification suggestion 2604 is selected by the administrator, the production management department server 3 sets the advance day count of the next process starting schedule modification suggestion 2604 as a new advance day count. This facilitates the administrator's work for adjusting the advance day count.

FIG. 28 is an explanatory diagram of the advance day count modifying screen 2600 according to the fifth embodiment of this invention that is displayed in the case where every period of the actual completion performance 2602 exceeds the period of the next process starting schedule 2603.

In the case where every period of the actual completion performance 2602 exceeds the period of the next process starting schedule 2603 as illustrated in FIG. 28, a production lead time used in the calculation of the advance day count could be inadequate. The production management department server 3 therefore calculates a production lead time for the display target product and the display target manufacturing process, and calculates the advance day count based on the calculated production lead time. The production management department server 3 displays a new next process starting schedule 2605 based on the newly calculated advance day count. The production management department server 3 then determines whether or not the period of the actual completion performance 2602 exceeds the period of the new next process starting schedule 2605 at some points in the manner described with reference to FIG. 26.

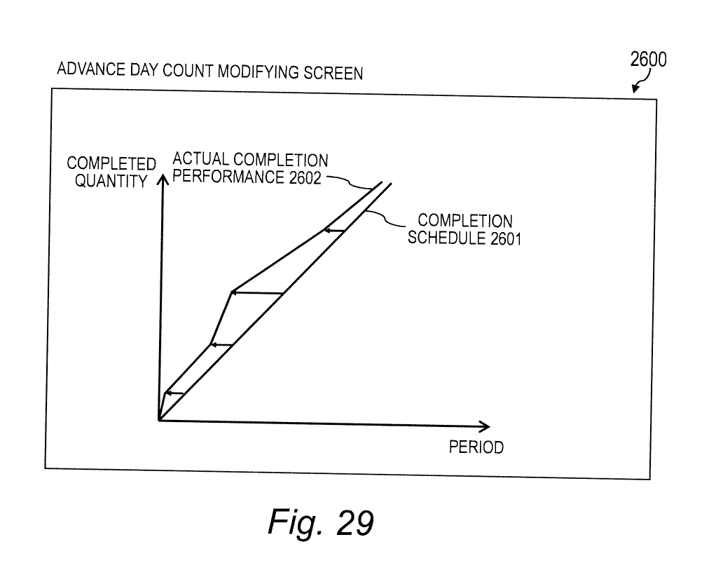

FIG. 29 is an explanatory diagram of the advance day count modifying screen 2600 according to the fifth embodiment of this invention that is displayed in the case where no period of the actual completion performance 2602 exceeds the period of the next process starting schedule 2603.

In the case where no period of the actual completion performance 2602 exceeds the period of the next process starting schedule 2603 as illustrated in FIG. 29, the production management department server 3 sets the advance day count to 0, and calculates a production lead time for the display target product and the display target manufacturing process.

In the manner described above, the production management department server 3 can modify the advance day count based on the relation between the period of the actual completion performance 2602 and the period of the next process starting schedule 2603, and can accordingly set an appropriate advance day count without burdening the administrator.

This invention is not limited to the embodiments described above, and encompasses various modification examples. For instance, while the embodiments above are described in detail for easier understanding of this invention, this invention is not limited to systems and methods that have all of the components described above. A part of the configuration of one embodiment can be replaced with the configuration of another embodiment, and an addition can be made to the configuration of one embodiment that is the configuration of another embodiment. In each embodiment, a part of the configuration of the embodiment can be modified by adding/removing/replacing other configurations.

The configurations, functions, processing parts, processing means, and the like described above may be partially or entirely implemented by hardware by, for example, designing those as an integrated circuit. The configurations, functions, and the like described above may also be implemented by software by interpreting and executing programs that implement the respective functions with a processor. The programs that implement the respective functions and other types of information such as tables and files can be put in a recording device such as a memory, a hard disk, or a solid state drive (SSD), or in a recording medium such as an IC card, an SD card, or a DVD.

What is claimed is:

1. A production management system for managing at least one process for producing a product, comprising:
a terminal for managing actual performance of the process; and
a management computer for managing the terminal,
wherein the terminal stores actual performance information which includes, for each product, an actual performance value in the process,
wherein the management computer stores reference information which includes, for each product, a reference value in the process, and
wherein the management computer is configured to:
obtain the actual performance information from the terminal;
compare, for each process, an actual performance value included in a piece of the obtained actual performance information of the process against a reference value included in a piece of the reference information that is associated with the process, to thereby calculate, for each process, a discrepancy of the actual performance value of the process from the reference value;
in a case where the calculated discrepancy is outside a threshold, display an alert display screen where every process for which the calculated discrepancy is outside the threshold is displayed in a manner that indicates an alert; and
in a case where one of the processes is selected on the alert display screen, display a details displaying screen that includes, for each product, an actual performance value in the selected process.

2. The production management system according to claim 1, wherein the management computer is configured to:
store, for each product, process order information in which order of processes is registered;
in a case where one of the products is selected on the details displaying screen, refer to the process order information in order to identify at least one of a process that precedes the selected process of the selected product and a process that follows the selected process of the selected product; and
display a process details displaying screen that includes an actual performance value of the selected product in the identified process.

3. The production management system according to claim 2,
wherein the at least one process includes a storing process for temporarily storing a product to be shipped to a shipping destination in a warehouse, and
wherein the management computer is configured to:
store actual order performance information including a request count, which indicates a count of pieces of a product requested by the shipping destination;
in a case where the process selected on the alert display screen is the storing process and one of the products is selected on the details displaying screen, refer to the process order information in order to identify the shipping destination of the selected product in the selected storing process;
refer to the actual order performance information of the identified shipping destination in order to obtain, as a current request count, the request count of the identified shipping destination in a given period; and
display the obtained current request count as the process details displaying screen of the shipping destination.

4. The production management system according to claim 3, wherein the management computer is configured to:
determine whether transition of the obtained request count is on a rising trend or a downward trend;
in a case where the transition of the obtained request count is on the downward trend, determine that the product is at a termination stage, and display a suggestion for a modification that lowers an upper limit value of a reference value for the storing process; and
in a case where the transition of the obtained request count is on the rising trend, determine that the product is at a debut stage, and display a suggestion for a modification that reduces a lower limit value of the reference value for the storing process.

5. The production management system according to claim 3, wherein the management computer is configured to:
in a case where displaying the process details displaying screen of the shipping destination, refer to the actual order performance information of the identified shipping destination in order to obtain, as a last request count, a request count in a period prior to the given period of the current request count to be obtained;
display the obtained current request count and the obtained last request count as the process details displaying screen of the shipping destination;
in a case where the obtained current request count is higher than the obtained last request count, display a suggestion for a modification that reduces a reference value for the storing process; and
in a case where the obtained current request count is lower than the obtained last request count, display a suggestion for a modification that increases the reference value for the storing process.

6. The production management system according to claim 1,
wherein the at least one process includes a first production process and a second production process in which a product produced through the first production process is processed in a given manner, and
wherein the management computer is configured to:
in order to improve an operating rate in the second production process, calculate, in advance, an advance period in which a product is produced ahead in the first production process, based on the actual performance information obtained from the terminal in the first production process;
store completion schedule information for registering a scheduled period in which a count of pieces of a product planned to complete production of the first production process reaches a given total count;
refer to the actual performance information obtained from the terminal in the first production process in order to calculate an actual period which is a length of time actually required to reach the total count registered in the completion schedule information;
in a case where the actual period is longer than the scheduled period, determine whether or not the actual period is longer than a period that is obtained by adding the advance period to the scheduled period; and
in a case where it is determined that the actual period is longer than the period obtained by adding the advance period to the scheduled period, display a suggestion to modify the advance period so that the actual period is equal to or less than the period obtained by adding the advance period to the scheduled period.

7. The production management system according to claim 1,
wherein the terminal stores, as the actual performance information, a count of products input to the process, a count of products completed in the process, and a count of defective products in relation to a cause of the defective products,
wherein, based on the actual performance information obtained from the terminal, the management computer calculates a yield which is a proportion of the count of defective products to the count of products input to the process,
wherein the reference information includes, for each product, a reference value associated with the yield of the product in the process, and
wherein the management computer is configured to:
in a case where one of the products is selected on the details displaying screen, display a process details display screen that includes a yield of the selected product and a reference value that is associated with the yield; and
in a case where one of the yields is selected on the process details displaying screen, refer to the actual performance information on which the calculation of the selected yield is based in order to display the count of defective products in relation to a cause of the defective products of the selected yield.

8. A management method for managing at least one process for producing a product in a production management system for managing the at least one process,
the production management system comprising:
a terminal for managing actual performance of the process; and
a management computer for managing the terminal,
the terminal storing actual performance information which includes, for each product, an actual performance value in the process,
the management computer storing reference information which includes, for each product, a reference value in the process,
the management method including:
obtaining, by the management computer, the actual performance information from the terminal;
comparing, by the management computer, for each process, an actual performance value included in a piece of the obtained actual performance information of the process against a reference value included in a piece of the reference information that is associated with the process, to thereby calculate, for each process, a discrepancy of the actual performance value of the process from the reference value;
in a case where the calculated discrepancy is outside a threshold, displaying, by the management computer, an alert display screen where every process for which the calculated discrepancy is outside the threshold is displayed in a manner that indicates an alert; and
in a case where one of the processes is selected on the alert display screen, displaying, by the management computer, a details displaying screen that includes, for each product, an actual performance value in the selected process.

9. The management method according to claim 8,
wherein the management computer stores, for each product, process order information in which order of processes is registered, and
wherein the management method further comprises:
in a case where one of the products is selected on the details displaying screen, referring, by the management computer, to the process order information in order to identify at least one of a process that precedes the selected process of the selected product and a process that follows the selected process of the selected product; and
displaying, by the management computer, a process details displaying screen that includes an actual performance value of the selected product in the identified process.

10. The management method according to claim 9,
wherein the at least one process includes a storing process for temporarily storing a product to be shipped to a shipping destination in a warehouse,
wherein the management computer stores actual order performance information including a request count, which indicates a count of pieces of a product requested by the shipping destination, and
wherein the management method further comprises:
in a case where the process selected on the alert display screen is the storing process and one of the products is selected on the details displaying screen, referring, by the management computer, to the process order information in order to identify the shipping destination of the selected product in the selected storing process;
referring, by the management computer, to the actual order performance information of the identified shipping destination in order to obtain, as a current request count, the request count of the identified shipping destination in a given period; and
displaying, by the management computer, the obtained current request count as the process details displaying screen of the shipping destination.

11. The management method according to claim 10, further comprising:
determining, by the management computer, whether transition of the obtained request count is on a rising trend or a downward trend;
in a case where the transition of the obtained request count is on the downward trend, determining, by the management computer, that the product is at a termination stage, and displaying a suggestion for a modification that lowers an upper limit value of a reference value for the storing process; and
in a case where the transition of the obtained request count is on the rising trend, determining, by the management computer, that the product is at a debut stage, and displaying a suggestion for a modification that reduces a lower limit value of the reference value for the storing process.

12. The management method according to claim 10, further comprising:
in a case of displaying the process details displaying screen of the shipping destination, referring, by the management computer, to the actual order performance information of the identified shipping destination in order to obtain, as a last request count, a request count in a period prior to the given period of the current request count to be obtained;
displaying, by the management computer, the obtained current request count and the obtained last request count as the process details displaying screen of the shipping destination;
in a case where the obtained current request count is higher than the obtained last request count, displaying, by the management computer, a suggestion for a modification that reduces a reference value for the storing process; and
in a case where the obtained current request count is lower than the obtained last request count, displaying, by the management computer, a suggestion for a modification that increases the reference value for the storing process.

13. The management method according to claim 8,
wherein the at least one process includes a first production process and a second production process in which a product produced through the first production process is processed in a given manner, and
wherein the management method further comprises:
in order to improve an operating rate in the second production process, calculating, by the management computer, in advance, an advance period in which a product is produced ahead in the first production process, based on the actual performance information obtained from the terminal in the first production process;
storing, by the management computer, completion schedule information for registering a scheduled period in which a count of pieces of a product planned to complete production of the first production process reaches a given total count;
referring, by the management computer, to the actual performance information obtained from the terminal in the first production process in order to calculate an actual period which is a length of time actually required to reach the total count registered in the completion schedule information;
in a case where the actual period is longer than the scheduled period, determining, by the management computer, whether or not the actual period is longer than a period that is obtained by adding the advance period to the scheduled period; and
in a case where it is determined that the actual period is longer than the period obtained by adding the advance period to the scheduled period, displaying, by the management computer, a suggestion to modify the advance period so that the actual period is equal to or less than the period obtained by adding the advance period to the scheduled period.

14. The management method according to claim 8,
wherein the terminal stores, as the actual performance information, a count of products input to the process, a count of products completed in the process, and a count of defective products in relation to a cause of the defective products,
wherein the management method further comprises calculating, by the management computer, based on the actual performance information obtained from the terminal, a yield which is a proportion of the count of defective products to the count of products input to the process,
wherein the reference information includes, for each product, a reference value associated with the yield of the product in the process, and
wherein the management method further comprises:
in a case where one of the products is selected on the details displaying screen, displaying, by the management computer, a process details display screen that includes a yield of the selected product and a reference value that is associated with the yield; and
in a case where one of the yields is selected on the process details displaying screen, referring, by the management computer, to the actual performance information on which the calculation of the selected yield is based in order to display the count of defective products in relation to a cause of the defective products of the selected yield.
